(19) United States
(12) Patent Application Publication
(10) Pub. No.: US 2013/0344427 A1
(43) Pub. Date: Dec. 26, 2013

(54) TONER, IMAGE FORMING APPARATUS, AND PROCESS CARTRIDGE

(71) Applicants: Takuya Kadota, Hyogo (JP); Yoshihiro Mikuriya, Hyogo (JP); Tsuyoshi Nozaki, Osaka (JP); Yoshimichi Ishikawa, Hyogo (JP); Kazuoki Fuwa, Hyogo (JP); Tomohiro Fukao, Osaka (JP); Tomoharu Miki, Osaka (JP); Masayuki Hagi, Osaka (JP); Hidekazu Shono, Hyogo (JP); Manabu Hamada, Osaka (JP); Tetsushi Sakuma, Osaka (JP)

(72) Inventors: Takuya Kadota, Hyogo (JP); Yoshihiro Mikuriya, Hyogo (JP); Tsuyoshi Nozaki, Osaka (JP); Yoshimichi Ishikawa, Hyogo (JP); Kazuoki Fuwa, Hyogo (JP); Tomohiro Fukao, Osaka (JP); Tomoharu Miki, Osaka (JP); Masayuki Hagi, Osaka (JP); Hidekazu Shono, Hyogo (JP); Manabu Hamada, Osaka (JP); Tetsushi Sakuma, Osaka (JP)

(21) Appl. No.: 14/003,931

(22) PCT Filed: Mar. 9, 2012
(86) PCT No.: PCT/JP12/56787

§ 371 Date: Sep. 9, 2013

(30) Foreign Application Priority Data
Mar. 9, 2011 (JP) 2011-051047
Mar. 2, 2012 (JP) 2012-046346

(51) Int. Cl. G03G 9/00; G03G 15/08

(52) U.S. Cl. CPC G03G 9/0827
USPC 430/105; 399/252; 430/109.1

(57) ABSTRACT

To provide a toner, which contains a binder resin, a colorant, and a silicone oil-treated external additive, wherein the silicone oil-treated external additive contains free silicone oil, and a total amount of the free silicone oil is 0.2% by mass to 0.5% by mass relative to the toner, and wherein the toner has the average circularity of 0.96 to 1.

### TECHNICAL FIELD

The present invention relates to a toner for developing latent electrostatic image formed in electrophotography, electrostatic recording, and electrostatic printing.

### BACKGROUND ART

Researches and developments of electrophotography have been conducted with various inventive ideas and technical approaches. In electrophotography, an image is formed by charging a surface of a latent image bearing member, developing a latent electrostatic image formed by exposing with a color toner to form a toner image, transferring the toner image to a recording medium such as transfer paper, and fixing the image by a heat roller or the like. The toner remained on the latent image bearing member without being transferred is removed by a cleaning blade or the like.

Recently, color image forming apparatuses utilizing an electrophotographic system have been widely distributed, and more highly precise images have been desired to be output because digitalized images are readily available. While studies have been conducted to provide images of higher resolution and gradation, spherical toners have been recently developed to accurately reproduce a latent electrostatic image, and production of more sphere and smaller toners has been studied. The toner produced by a pulverization method has a limit to provide these properties, and therefore polymerization toners produced by a suspension polymerization method, an emulsification polymerization method, and a dispersion polymerization method, which can form more sphere and smaller toners, has been employed.

The polymerization toner has a problem in cleaning properties because of the spherical shape of the particles.

Specifically, the spherical toner has problems that it is difficult to remove the toner remained on a latent image bearing member, and the toner may smear a charging roller, or causes image defect due to the toner remained on the latent image bearing member. Currently, it is moreover important that functional members have long service life to perform printing at low cost. Among such members, a technique for prolonging the service life of the latent image bearing member has been developed, but it is necessary to overcome a problem of a film abrasion due to frictions with a cleaning blade to give a latent image bearing member a long service life.

Various proposals have been made to improve the cleaning properties. For example, PTL 1 discloses that as an external additive, a surface-modified inorganic oxide powder is used and the surface-modified inorganic oxide powder is an inorganic oxide powder, which is surface treated with reactive modified silicone oil, has a carbon fixation rate of 90% or higher, and hydrophobicity of 95% or higher. Since this external additive has the high silicone oil fixation rate, i.e., 90% or higher, sufficient free silicone oil cannot be secured even when 5 parts by mass thereof is added. Therefore, such external additive is insufficient to improve the cleaning properties, and reduce the film abrasion amount of the latent image bearing member.

PTL 2 discloses use of an external additive, which is formed of inorganic particles containing silicone, and has the free silicone oil rate of 10% by mass to 65% by mass. This external additive gives a small amount of free silicone oil in the toner, and therefore it is not sufficient to improve the cleaning properties, and reduce the film abrasion amount of the latent image bearing member.

PTL 3 discloses use of an external additive, which is silicon oxide surface-treated with silicone oil and has a free oil amount of lower than 3% by mass. The proposed external additive however has a high oil fixation rate, i.e., the free silicone oil rate being lower than 3% by mass, and the sufficient amount of the free silicone oil cannot be secured. Therefore, it is not sufficient to improve the cleaning properties of the spherical toner, and reduce the film abrasion amount of the latent image bearing member.

PTL 4 discloses use of an external additive, which is silica particles treated with silicone oil, having the average primary particle diameter of 50 nm to 150 nm, and the free oil amount of 0.1% by mass to 3% by mass. In this proposal, however, the free silicone oil amount in the toner is only about 0.15% by mass calculated from the free silicone oil amount in the external additive described in Examples, and therefore it is not sufficient to improve the cleaning properties of the spherical toner and to reduce the film abrasion amount of the latent image bearing member.

PTL 5 discloses use of an external additive, which is formed of hydrophobic-treated inorganic particles having the average primary particle diameter of 100 nm or smaller, has the hydrophobizing agent residual ratio of 40% to 98.5% on weight bases, and contains at least a compound having an organopolysiloxane structure in the residual component of a solvent treatment of the hydrophobic-treated inorganic particles. In this proposal, however, an amount of the silicone oil added to the external additive is small according to its Examples, and moreover the amount thereof to the toner is small. The amount of the free silicone oil, which is desired, is small, and therefore it is not sufficient to improve the cleaning properties of the spherical toner and reduce the film abrasion amount of the latent image bearing member.

### CITATION LIST

### Patent Literature

PTL 1: Japanese Patent Application Laid-Open (JP-A) No. 2009-292915
PTL 2: JP-A No. 2009-98700
PTL 3: JP-A No. 2009-25744
PTL 4: JP-A No. 2009-98194
PTL 5: JP-A No. 2002-148847

### SUMMARY OF INVENTION

### Technical Problem

The present invention aims to provide an inexpensive electrophotographic toner, image forming apparatus and process cartridge, in all of which cleaning ability of a spherical toner is improved in any environment, service life of a latent image bearing member is improved, and images of high quality are formed.

The present invention aims to provide an inexpensive electrophotographic toner, image forming apparatus and process cartridge, in all of which cleaning ability of a spherical toner is improved in any environment, service life of a latent image bearing member is improved, depositions on a developing member is prevented, and images of high quality are formed.

### Solution to Problem

The means for solving the aforementioned problems are as follow:

A toner, which contains:

a binder resin;

a colorant; and

a silicone oil-treated external additive,

wherein the silicone oil-treated external additive contains free silicone oil, and a total amount of the free silicone oil is 0.2% by mass to 0.5% by mass relative to the toner, and

wherein the toner has the average circularity of 0.96 to 1.

### Advantageous Effects of Invention

Use of the toner of the present invention enables to form a stopper layer with a silicone oil-treated silica, which is an external additive, to thereby clean the spherical toner with the stopper layer.

Since the toner has a certain amount of the free silicone oil, moreover, the friction between a latent image bearing member and a cleaning blade reduces, to thereby prevent the film abrasion of the outermost layer of the latent image bearing member, leading to long service life of the latent image bearing member.

Further, an image forming method and image forming apparatus using the toner of the present invention enable to form high quality images in any environment.

Furthermore, the present invention can provide an inexpensive electrophotographic toner, image forming apparatus and process cartridge, in all of which an ability of cleaning a spherical toner from an intermediate transfer member over a long period is improved in any environment, a long service life of the intermediate transfer member is realized, deposition on a developing member is prevented, and excellent images are formed.

### BRIEF DESCRIPTION OF DRAWINGS

FIG. 1 is a diagram illustrating a state of a stopper layer formed on a font surface of a cleaning blade.

FIG. 2 is a schematic diagram illustrating one example of the image forming apparatus of the present invention.

FIG. 3 is a schematic diagram illustrating a soft roller fixing member containing a fluorine-based surface layer.

FIG. 4 is a schematic diagram illustrating one example of a multi-color image forming apparatus.

FIG. 5 is a schematic diagram illustrating one example of a full-color image forming apparatus with a revolver developing unit.

FIG. 6 is a schematic diagram illustrating one example of a structure of a process cartridge.

FIG. 7 is a schematic diagram illustrating one example of a cleaning unit for use in the image forming apparatus of the present invention.

FIG. 8 is an explanatory diagram illustrating one example of a cleaning unit.

FIG. 9 is an explanatory diagram illustrating one example of a cleaning blade of a cleaning unit.

FIG. 10 is a conception diagram illustrating the definition of the total amount of free silicone oil in the toner.

### DESCRIPTION OF EMBODIMENTS

### (Toner)

The toner of the present invention contains at least a binder resin, a colorant, and a silicone oil-treated external additive, and may further contain other components, if necessary.

### <External Additive>

The silicone oil used in the silicone oil-treated external additive is not particularly restricted, and examples thereof include dimethyl silicone oil, polydimethyl siloxane (PDMS) oil, methylphenyl silicone oil, chlorophenyl silicone oil, methylhydrogen silicone oil, alkyl-modified silicone oil, fluorin-modified silicone oil, polyether-modified silicone oil, alcohol-modified silicone oil, amino-modified silicone oil, epoxy-modified silicone oil, epoxy polyether-modified silicone oil, phenol-modified silicone oil, carboxyl-modified silicone oil, mercapto-modified silicone oil, acryl, methacryl-modified silicone oil, and α-methylstyrene-modified silicone oil. These may be used independently, or in combination. Among them, polydimethyl siloxane (PDMS) oil is particularly preferable.

Examples of the inorganic particles constituting the external additive include silica, alumina, titania (titanium oxide), barium titanate, magnesium titanate, calcium titanate, strontium titanate, iron oxide, copper oxide, zinc oxide, tin oxide, quartz sand, clay, mica, wollastonite, diatomaceous earth, chromic oxide, cerium oxide, red iron oxide, antimony trioxide, magnesium oxide, zirconium oxide, barium sulfate, barium carbonate, calcium carbonate, silicon carbide, and silicon nitride. These may be used independently, or in combination. Among them, silica, titania, and alumina are preferable.

These inorganic particles may be used independently, or in combination for an electrophotographic toner.

An amount of the inorganic particles is preferably 0.1% by mass to 5% by mass, more preferably 0.3% by mass to 4% by mass, relative to the toner.

The average particle diameter of primary particles of the silicone-oil treated inorganic particles is preferably 30 nm to 150 nm, more preferably 30 nm to 100 nm. When the average particle diameter thereof is larger than the aforementioned range, the surface areas of the inorganic particles are small so that the total amount of the silicone oil carried on the inorganic particles becomes small, and therefore the effect of free silicone oil may not be sufficiently exhibited even though the amount of the free silicone oil is set in the present invention. When the average particle diameter thereof is smaller than the aforementioned range, the inorganic particles are hardly free from the toner, so that a stopper layer necessary for cleaning is hardly formed even though the amount of the free silicone oil is set in the present invention. Therefore, the desirable effect may not be sufficiently exhibited. Note that, the average particle diameter mentioned here is the number average particle diameter.

The average primary particle diameter of the inorganic particles as the external additive can be measured by a particle size distribution measuring device utilizing dynamic light scattering, for example, DLS-700 of Otsuka Electronics Co., Ltd., or Coulter N4 of Beckman Coulter, Inc.

It is however preferred that particle diameters be measured directly from a photograph obtained by a scanning electron microscope or transmission electron microscope, as it is difficult to dissociate secondary aggregation of particles after a silicone oil treatment.

In this case, at least one hundred inorganic particles are observed, and the average value of the major axis of the inorganic particles is determined.

The BET specific surface area of the external additive is preferably 10 m²/g to 50 m²/g. When the BET specific surface area is smaller than 10 m²/g, the total amount of the silicone oil carried on the inorganic particles becomes small, and therefore the effect of free silicone oil may not be sufficiently exhibited even though the amount of the free silicone oil is set in the present invention. When the BET specific surface area is larger than 50 m²/g, it is difficult to form a stopper layer necessary for cleaning even though the amount of the free silicone oil is set in the present invention, and thus the desirable effect may not be sufficiently exhibited.

Here, the measurement of the BET specific surface area of the external additive is performed in the following manner using a surface area analyzer Autosorb-1 of Quantachrome Corporation.

About 0.1 g of a measurement sample is weight and poured in a cell, and is subjected to deaeration at the temperature of 40° C. and the vacuum degree of 1.0×10⁻³ mmHg or lower for 12 hours or longer.

Thereafter, nitrogen gas is introduced to be adsorbed on the sample in the cooled state by liquid nitrogen, and the value is measured by a multi-point method.

### —Free Silicone Oil—

The free silicone oil described in the present invention include the silicone oil which is physically adsorbed by pores in a surfaces of the inorganic particles, not necessarily chemically bonded to the surfaces of the inorganic particles. More specifically, the free silicone oil is a component which is easily detached from the inorganic particles when it is touched.

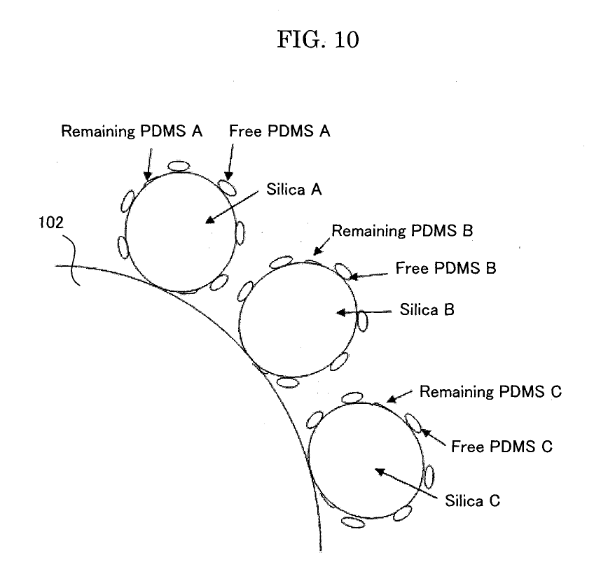

Here, FIG. 10 is a conception diagram illustrating the definition of the total amount of the free silicone oil in the toner.

Total amount of free polydimethyl siloxane(PDMS) in the silicone oil-treated silica=amount of free PDMS A+amount of free PDMS B+amount of free PDMS C

Total amount of free PDMS in toner=[(amount of free PDMS A+amount of free PDMS B+amount of free PDMS C)/amount of toner]×100

The free silicone oil is a portion of the silicone oil, which can be removed by chloroform, and this portion can be removed by external contact or external stress.

The remaining silicone oil is a portion of the silicone oil, which cannot be removed by chloroform, and this portion cannot be removed by external contact or external stress.

The removed silicone oil is transferred to a latent image bearing member, and intermediate transfer member to thereby contribute to reduce friction with a cleaning blade. As a result, the vibration caused by the cleaning blade is inhibited, and reduces a space formed between the latent image bearing member or intermediate transfer member with the cleaning blade at the time of vibration, so that the toner having the high average circularity can be cleaned.

The total amount of the free silicone oil is 0.2% by mass to 0.5% by mass, preferably 0.3% by mass to 0.5% by mass, and more preferably 0.3% by mass to 0.4% by mass, relative to the toner.

When the total amount of the free silicone oil in the toner is smaller than 0.2% by mass, cleaning performance may be lowered, and a film abrasion amount of the latent image bearing member may increase. When the total amount thereof is larger than 0.5% by mass, depositions on a developing member may occur, for example, a regulating blade used in one-component developing may be smeared, and as the printing operation is continued to be repeated, the charging ability lowers, and the charge amount of the toner reduced due to the depositions.

The measurement of the amount of the free silicone oil (free silicone oil amount) in the toner can be measured by a quantitative method containing the following steps (1) to (3):

### (1) Extraction of Free Silicone Oil

A sample toner is soaked in chloroform, stirred, and left to stand.

To the solids obtained after removing a supernatant liquid by centrifugal separation, chloroform is added, and the resultant is stirred, and left to stand. This operation is repeated to remove free silicone oil from the sample.

### (2) Determination of Carbon Content

The carbon content of the sample from which the free silicone oil has been removed is measured by CHN elemental analyzer (CHN corder MT-5 (of Yanaco Co., Ltd.)).

### (3) Determination of Free Silicone Oil Amount

An amount of the free silicone oil is obtained by the following equation (1).

Free silicone oil amount=(C0−C1)/C×100×40/12(% by mass) Equation (1)

In the equation above, “C” is a carbon content (% by mass) of the silicone oil treating agent, “C0” is a carbon content (% by mass) of the sample before the extraction, “C1” is a carbon content (% by mass) of the sample after the extraction, and the coefficient “40/12” is the conversion factor for converting from the C (carbon) amount in the structure of the polydimethyl siloxane to the total amount

The structural formula of the polydimethyl siloxane is presented below:

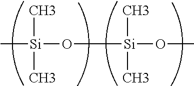

### —Method of Silicone Oil Treatment—

The inorganic particles, which have been previously dewatered, and dried in an oven at the temperature of several hundreds degrees Celsius, and silicone oil are uniformly brought into contact to each other to thereby deposit the silicone oil on the surfaces of the inorganic particles.

In order to deposit the silicone oil on the inorganic particles, the inorganic particles and the silicone oil are sufficiently mixed as powders by means of a mixer such as of a rotating blade. Alternatively, the silicone oil is dissolved in a solvent capable of diluting the silicone oil and having a relatively low boiling point, the inorganic particles are soaked in the resulting solution, and the solvent is removed by drying to thereby deposit the silicone oil on the inorganic particles.

When the viscosity of the silicone oil is high, the inorganic particles are preferably treated in a liquid.

Thereafter, the inorganic particles on which the silicone oil has been deposited is subjected to a heat treatment in an oven at the temperature of 100° C. to several hundreds degrees Celsius. As a result, a metal and the silicone oil may form a siloxane bond using the hydroxyl group on the surfaces of the inorganic particles, and silicone oil itself can be further polymerized, or crosslinked.

The aforementioned reaction may be accelerated by adding a catalyst (e.g., acid, alkali, a metal salt, zinc octoate, tin octoate, and dibutyl tin dilaurate) to the silicone oil in advance to the reaction.

Moreover, in advance to the silicone oil treatment, the inorganic particles may be subjected to a treatment with a hydrophobizing agent, such as a silane coupling agent.

The inorganic particles which have been hydrophobized in advance have a larger adsorption amount of the silicone oil compared to those without the hydrophobizing treatment.

An amount of the silicone oil added to the external additive is preferably 2 mg/m² to 10 mg/m² with respect to a surface area of the external additive. When the amount thereof is smaller than 2 mg/m², a sufficient amount of the free silicone oil cannot be secured in the toner so that the sufficient cleaning properties may not be attained. When the amount thereof is larger than 10 mg/m², an amount of the free silicone oil in the toner is too large, which may cause filming of the silicone oil on the latent image bearing member or developing unit, causing image failures.

The effect of the free silicone oil obtainable in the present invention will be explained.

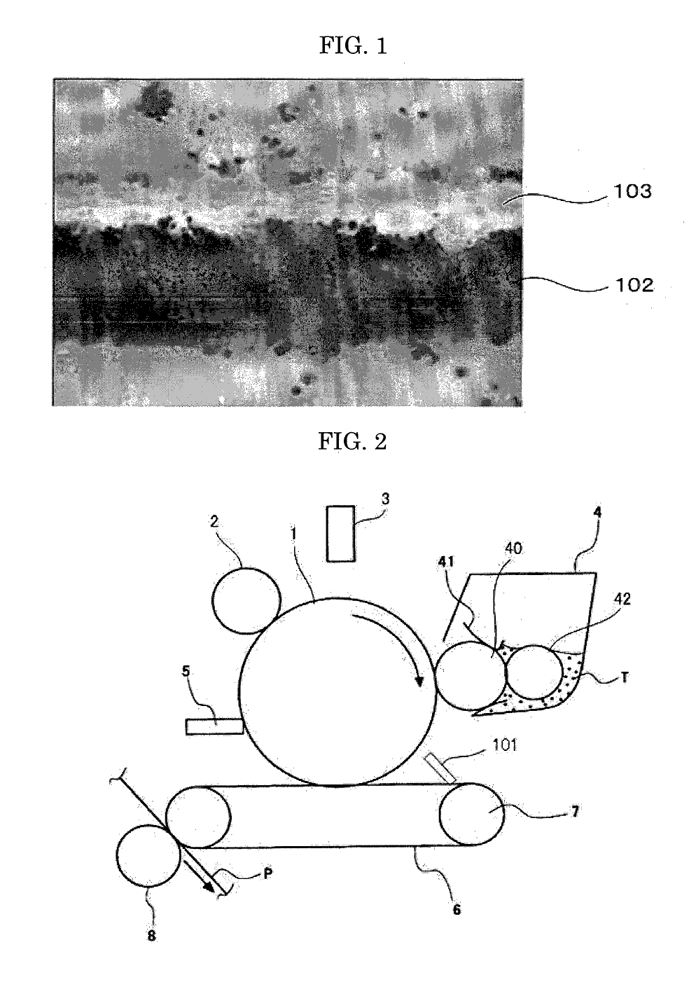

FIG. 1 is a photograph capturing the state adjacent to the cleaning blade when image formation is performed using the toner of the present invention. A stopper layer 103 is formed with the silicone oil-treated silica on the front surface of the cleaning blade, between the toner and the cleaning blade. This stopper layer 103 prevents the toner 102 from slipping away from the cleaning blade. Moreover, a certain amount of the free silicone oil is provided to reduce friction between the latent image bearing member and the cleaning blade, and therefore the film abrasion of the surface layer of the latent image bearing member can be prevented.

### —Other Inorganic Particles; Minute External Additive—

In the present invention, at least one minute external additive may be used together with a plasticizer, and conventional inorganic particles which have not been subjected to a surface treatment and/or conventional inorganic particles which have been surface-treated with a hydrophobizing agent other than silicone oil are used as the minute external additive.

Examples of the hydrophobizing agent include a silane coupling agent, a sililating agent, a silane coupling agent containing a fluoroalkyl group, an organic titanate-based coupling agent, and an aluminum-based coupling agent. Examples of the inorganic particles include silica, alumina, titanium oxide, barium titanate, magnesium titanate, calcium titanate, strontium titanate, zinc oxide, tin oxide, quartz sand, clay, mica, wollastonite, diatomaceous earth, chromic oxide, cerium oxide, red iron oxide, antimony trioxide, magnesium oxide, zirconium oxide, barium sulfate, barium carbonate, calcium carbonate, silicon carbide, and silicon nitride. These may be used independently, or in combination.

As for the inorganic particles used in combination, inorganic particles having the average particle diameter smaller than that of the silicone oil-treated inorganic particles are suitably used.

Use of these small inorganic particles increases the coverage of the toner surface, which contributes to give appropriate flowability to a developer and to secure accurate reproducibility of a latent image or developing amount during developing.

Moreover, aggregations or solidification of the toner can be prevented during storage of the developer.

An amount of the aforementioned other inorganic particles is preferably 0.01% by mass to 5% by mass, more preferably 0.1% by mass to 2% by mass, relative to the toner.

### —Cleaning Auxiliary—

A cleaning improving agent may be used in combination for removing the developer remained on a latent image bearing member or primary transfer medium after transferring.

Examples of the cleaning improving agent include: fatty acid metal salt such as zinc stearate, calcium stearate, and stearic acid; and polymer particles produced by soap-free emulsification polymerization such as polymethylmethacrylate particles, and polystyrene particles. As for the polymer particles, those having a relatively narrow particle size distribution, and having the volume average particle diameter of 0.01 μm to 1 μm are preferable.

### —Resin Particles—

As for the resin particles, for example, particles formed of polystyrene, methacrylic acid ester, or acrylic acid ester copolymer obtained by soap-free emulsification polymerization, suspension polymerization, or dispersion polymerization; polymerization condensation polymer particles such as silicone, benzoguanamine, and nylon; or polymer particles formed of a thermoset resin may be used in combination during adding external additives.

Use of these resin particles in combination enables to enhance the charging ability of the developer, reducing the number of the reversely charged toner particles, and reducing the background deposition.

An amount of the resin particles is preferably 0.01% by mass to 5% by mass, more preferably 0.1% by mass to 2% by mass, relative to the toner.

### <Binder Resin>

As for the binder resin, a polyester resin is suitably used.

Examples of the polyester resin include ring-opening polymerization products of lactones, condensation polymerization product of hydroxycarboxylic acid, and polycondensates of polyol and polycarboxylic acid. Among them, the polycondensate of polyol and polycarboxylic acid is preferable in view of a variance in designing.

The peak molecular weight of the polyester resin is preferably 1,000 to 30,000, more preferably 1,500 to 10,000, and even more preferably 2,000 to 8,000. When the peak molecular weight thereof is 1,000 or larger, the desirable heat resistance storage stability is provided to the resulting toner. When the peak molecular weight thereof is 30,000 or smaller, the desirable low temperature fixing ability is provided to the resulting toner.

The glass transition temperature of the polyester resin is preferably 35° C. to 80° C., more preferably 40° C. to 70° C., even more preferably 45° C. to 65° C. When the glass transition temperature thereof is 35° C. or higher, the following problems are avoided, namely, deforming of the toner in the high temperature environment, such as in summer, or losing the original performances as particles because the toner particles are attached to each other. When the glass transition temperature thereof is 80° C. or lower, the resulting toner has excellent fixing ability.

The toner of the present invention can be obtained through a step for dissolving and dispersing a resin, a colorant, and a releasing agent, which form a main part of the toner, in a solvent, and a step for dispersing the solution or dispersion in an aqueous medium to perform granulation. Moreover, the toner having a core-shell structure can be obtained through a step for adding a resin particle dispersion liquid, in which resin particles for forming protrusions (shells) are dispersed, to a core particle dispersion liquid, in which the toner obtained through the aforementioned steps is contained as core particles, to thereby form protrusions formed of the resin particles on the surfaces of the core particles, and a step for removing the organic solvent from the dispersion liquid of the core particles on the surfaces of which the protrusions (shells) have been formed. In the present invention, the toner is preferably the toner having a core-shell structure. Note that, in the present specification, the toner particles before the external additives are added may be referred to as toner base particles.

Examples of the polyester resin include polycondensates of the following polyol (1) and the following polycarboxylic acid (2), and any polyester resin can be used. Moreover, a plurality of polyester resins may be used in a mixture.

### —Polyol—

Examples of the polyol (1) include alkylene glycol (e.g., ethylene glycol, 1,2-propylene glycol, 1,3-propylene glycol, 1,4-butanediol, and 1,6-hexanediol); alkylene ether glycol (e.g., diethylene glycol, triethylene glycol, dipropylene glycol, polyethylene glycol, polypropylene glycol, and polytetramethylene ether glycol); alicyclic diol (e.g., 1,4-cyclohexanedimethanol, and hydrogenated bisphenol A); bisphenols (e.g., bisphenol A, bisphenol F, bisphenol S, and 3,3′-difluoro-4,4′-dihydroxybiphenyl), 4,4′-dihydroxybiphenyls; bis(hydroxyphenyl)alkanes such as bis(3-fluoro-4-hydroxyphenyl)methane, 1-phenyl-1,1-bis(3-fluoro4-hydroxyphenyl)ethane, 2,2-bis(3-fluoro-4-hydroxyphenyl)propane, 2,2-bis(3,5-difluoro-4-hydroxyphenyl)propane (another name: tetrafluorobisphenol A), and 2,2-bis(3-hydroxyphenyl)-1,1,1,3,3,3-hexafluoropropane; bis(4-hydroxyphenyl)ethers such as bis(3-fluoro-4-hydroxyphenyl)ether; alkylene oxide (e.g., ethylene oxide, propylene oxide, and butyleneoxide) adducts of the alicyclic diol; and alkylene oxide (e.g., ethylene oxide, propylene oxide, and butyleneoxide) adducts of the bisphenols.

Among them, the C2-C12 alkylene glycol and the alkylene oxide adduct of the bisphenols are preferable, and the alkylene oxide adduct of the bisphenols, and a combination of the alkylene oxide adduct of the bisphenols and the C2-C12 alkylene glycol are more preferable.

Further, another examples thereof include: tri- to octa- or higher polyhydric aliphatic alcohol (e.g., glycerin, trimethylol ethane, trimethylol propane, pentaerythritol, and sorbitol); trihydric or higher phenols (e.g., trisphenol PA, phenol novolak, and cresol novolak); and alkylene oxide adducts of the trihydric or higher polyphenols.

Note that, the polyol may be used independently or in combination, and the polyol is not limited to the examples listed above.

### —Polycarboxylic Acid—

Examples of the polycarboxylic acid (2) include alkylene dicarboxylic acid (e.g., succinic acid, adipic acid, and sebacic acid); alkenylene dicarboxylic acid (e.g., maleic acid, and fumaric acid); and aromatic dicarboxylic acid (e.g., phthalic acid, isophthalic acid, terephthalic acid, naphthalene dicarboxylic acid, 3-fluoroisophthalic acid, 2-fluoroisophthalic acid, 2-fluoroterephthalic acid, 2,4,5,6-tetrafluoroisophthalic acid, 2,3,5,6-tetrafluoroterephthalic acid, 5-trifluoromethylisophthalic acid, 2,2-bis(4-carboxyphenyl)hexafluoropropane, 2,2-bis(4-carboxyphenyl)hexafluoropropane, 2,2-bis(3-carboxyphenyl)hexafluoropropane, 2,2′-bis(trifluoromethyl)-4,4′-biphenyldicarboxylic acid, 3,3′-bis(trifluoromethyl)-4,4′-biphenyldicarboxylic acid, 2,2′-bis(trifluoromethyl)-3,3′-biphenyldicarboxylic acid, and hexafluoroisopropylidene diphthalic acid anhydride).

Among them, the C4-C20 alkenylene dicarboxylic acid and the C8-C20 aromatic dicarboxylic acid are preferable. Further, examples of the trivalent or higher polycarboxylic acid include C9-C20 aromatic polycarboxylic acid (e.g., trimellitic acid, and pyromellitic acid). Moreover, acid anhydrides or lower alkyl ester (e.g., methyl ester, ethyl ester, and isopropyl ester) of the preceding polycarboxylic acids may be used to react with the polyol (1).

Note that, the polycarboxylic acid may be used independently or in combination, and is not limited to the examples listed above.

The ratio of the polyol (1) and the polycarboxylic acid (2) is determined as an equivalent ratio [OH]/[COOH] of the hydroxyl group [OH] to the carboxyl group [COOH] and the equivalent ratio [OH]/[COOH] is preferably 2/1 to 1/1, more preferably 1.5/1 to 1/1, and even more preferably 1.3/1 to 1.02/1.

The peak molecular weight of the polyester resin is preferably 1,000 to 30,000, more preferably 1,500 to 10,000, and even more preferably 2,000 to 8,000. When the peak molecular weight thereof is smaller than 1,000, the resulting toner may have insufficient heat resistance storage stability. When the peak molecular weight thereof is larger than 30,000, the resulting toner may have insufficient low temperature fixing ability.

### <<Modified Polyester Resin>>

The binder resin may contain a modified polyester resin containing a urethane and/or urea group for adjusting the viscoelasticity.

An amount of the modified polyester resin containing a urethane and/or urea group in the binder resin is preferably 20% by mass or smaller, more preferably 15% by mass or smaller, and even more preferably 10% by mass or smaller. When the amount thereof is larger than 20% by mass, the resulting toner may have insufficient low temperature fixing ability.

The modified polyester resin containing a urethane and/or urea group may be directly mixed with the binder resin, but it is preferred in view of the productivity that a relatively low molecular weight modified polyester resin containing an isocyanate group at a terminal thereof (may also referred to as “prepolymer” hereinafter) and amines reactive with the prepolymer be added to and mixed with the binder resin, and be allowed to undergo a chain elongation and/or crosslink reaction during and/or after granulation to thereby form a modified polyester resin containing a urethane and/or urea group. In this manner, the relatively high molecular weight modified polyester resin can be easily added to the binder resin for adjusting the viscoelasticity.

### —Prepolymer—

Examples of the prepolymer containing the isocyanate group include polycondensate of the polyol (1) and the polycarboxylic acid (2), and a compound resulted from a reaction between polyester containing an active hydrogen group and polyisocyanate (3). Examples of the active hydrogen group contained in the polyester include a hydroxyl group (e.g., an alcoholic hydroxyl group, and a phenolic hydroxyl group), an amino group, a carboxyl group, and a mercapto group. Among them, an alcoholic hydroxyl group is particularly preferable.

Examples of the polyisocyanate (3) include: aliphatic polyisocyanate (e.g., tetramethylene diisocyanate, hexamethylene diisocyanate, and 2,6-diisocyanate methyl caproate); alicyclic polyisocyanate (e.g., isophorone diisocyanate, and cyclohexylmethane diisocyanate); aromatic diisocyanate (e.g., tolylene diisocyanate, and diphenylmethane diisocyanate); aromatic aliphatic diisocyanate (e.g., α,α,α′,α′-tetramethyl xylylene diisocyanate); isocyanurates; and the preceding polyisocyanates blocked with phenol derivatives, oxime, or caprolactam. These may be used independently, or in combination.

The ratio of the polyisocyanate (3) is determined as an equivalent ratio ([NCO]/[OH]) of the isocyanate group [NCO] to the hydroxyl group [OH] of the polyester, and the equivalent ratio ([NCO]/[OH]) is preferably 5/1 to 1/1, more preferably 4/1 to 1.2/1, and even more preferably 2.5/1 to 1.5/1. When the equivalent ratio is greater than 5, the resulting toner may have insufficient low temperature fixing ability. When the molar ratio of the [NCO] is smaller than 1, the urea content of the modified polyester is low, which may result in poor offset resistance of the toner. An amount of the polyisocyanate (3) constitutional unit in the prepolymer (A) containing an isocyanate group at a terminal thereof is preferably 0.5% by mass to 40% by mass, more preferably 1% by mass to 30% by mass, and even more preferably 2% by mass to 20% by mass. When the amount thereof is smaller than 0.5% by mass, the resulting toner may have insufficient offset resistance. When the amount thereof is larger than 40% by mass, the resulting toner may have insufficient low temperature fixing ability.

The number of the isocyanate groups contained per molecule of the prepolymer (A) containing an isocyanate group is preferably 1 or more, more preferably 1.5 to 3 on average, and even more preferably 1.8 to 2.5 on average. When the number thereof per molecule is less than 1, the molecular weight of the modified polyester after the chain elongation and/or crosslink reaction is small, which may results in the insufficient offset resistance of the resulting toner.

—Chain Elongation and/or Crosslinking Agent—

As for the chain elongation and/or crosslinking agent, amines can be used. Examples of the amines (B) include diamine (B1), tri, or higher polyamine (B2), amino alcohol (B3), amino mercaptan (B4), amino acid (B5), and a blocked compound (B6) where an amino group of any of the preceding B1 to B5 is blocked.

Examples of the diamine (B1) include aromatic diamine, alicyclic diamine, and aliphatic diamine.

Examples of the aromatic diamine include phenylene diamine, diethyl toluene diamine, 4,4′-diaminodiphenyl methane, tetrafluoro-p-xylene diamine, and tetrafluoro-p-phenylene diamine.

Examples of the alicyclic diamine include 4,4′-diamino-3,3′-dimethyldicyclohexyl methane, diamine cyclohexane, and isophorone diamine.

Examples of the aliphatic diamine include ethylene diamine, tetramethylene diamine, hexamethylene diamine, dodecafluorohexylene diamine, and tetracosafluorododecylene diamine.

Examples of the tri or higher polyamine (B2) include diethylene triamine, and triethylene tetramine.

Examples of the amino alcohol (B3) include ethanol amine, and hydroxyethyl aniline.

Examples of the amino mercaptan (B4) include aminoethylmercaptan, and aminopropylmercaptan.

Examples of the amino acid (B5) include amino propionic acid, and amino caproic acid.

Examples of the blocked compound (B6) where an amino group of any of the preceding B1 to B5 is blocked include a ketimine compound and oxazoline compound obtained from the amines of B1 to B5 and ketones (e.g., acetone, methyl ethyl ketone and methyl isobutyl ketone).

Moreover, the chain elongation and/or crosslink reaction may be optionally ended using a terminator to thereby adjust a molecular weight of modified polyester after the reaction. Examples of the terminator include monoamine (e.g., diethyl amine, dibutyl amine, butyl amine, and lauryl amine), and blocked compounds of the preceding monoamine (e.g., a ketimine compound).

As for the ratio of the amines (B), an equivalent ratio ([NCO]/[NHx]) of the isocyanate group [NCO] contained in the prepolymer (A) containing an isocyanate group to the amino group [NHx] contained in the amines (B) is preferably 1/2 to 2/1, more preferably 1.5/1 to 1/1.5, and even more preferably 1.2/1 to 1/1.2. When the equivalent ratio ([NCO]/[NHx]) is larger than 2/1 or smaller than 1/2, the molecular weight of the resulting urea-modified polyester (i) is small, which may result in insufficient hot offset resistance of the resulting toner.

### <<Crystalline Polyester Resin>>

The toner of the present invention may contain a crystalline polyester resin for improving low temperature fixing ability.

The crystalline polyester resin is also obtained as the aforementioned polycondensate of polyol and polycarboxylic acid.

As for the polyol, aliphatic diol is preferable, and specific examples thereof include ethylene glycol, 1,2-propylene glycol, 1,3-propylene glycol, 1,4-butanediol, 1,5-pentanediol, 1,6-hexanediol, 1,7-heptanediol, 1,8-octanediol, neopentyl glycol, and 1,4-butenediol. These may be used independently or in combination. Among them, 1,4-butanediol, 1,6-hexanediol, and 1,8-octanediol are preferable, and 1,6-hexanediol is particularly preferable.

Examples of the polycarboxylic acid include aromatic dicarboxylic acid (e.g., phthalic acid, isophthalic acid, and terephthalic acid), and C2-C8 aliphatic carboxylic acid. Among them, aliphatic carboxylic acid is preferable for increasing crystallization degree.

Note that, the crystalline resin (e.g., crystalline polyester) and the non-crystalline resin are distinguished from each other based on the thermal properties thereof. The crystalline resin is, for example, a resin having a clear endothermic peak in a DSC measurement, as wax does. The non-crystalline resin is a resin exhibiting a gentle curve based on a glass transition temperature in a DSC measurement.

### —Vinyl Resin Particles for Shell Layer—

As for a shell layer resin for use in the present invention, a vinyl resin is preferably used.

Resin particles formed of the vinyl resin can be formed by polymerizing a monomer mixture containing mainly, as a monomer, an aromatic compound containing a vinyl polymerizable functional group.

An amount of the aromatic compound containing a vinyl polymerizable functional group in the monomer mixture is preferably 80% by mass to 100% by mass, more preferably 80% by mass to 95% by mass, and even more preferably 80% by mass to 90% by mass. When the amount of the aromatic compound containing a vinyl polymerizable functional group is smaller than 80% by mass, the resulting toner may have poor charging ability.

Examples of the polymerizable functional group in the aromatic compound containing the vinyl polymerizable functional group include a vinyl group, an isopropenyl group, an allyl group, an acryloyl group, and a methacryloyl group.

Specific examples of the monomer include styrene, α-methylstyrene, 4-methylstyrene, 4-ethylstyrene, 4-tert-butylstyrene, 4-methoxystyrene, 4-ethoxystyrene, 4-carboxystyrene or a metal salt thereof, 4-styrene sulfonic acid or a metal salt thereof, 1-vinylnaphthalene, 2-vinylnaphthalene, allyl benzene, butyl acrylate, phenoxyalkylene glycol acrylate, phenoxyalkylene glycol methacrylate, phenoxypolyalkylene glycol acrylate, phenoxypolyalkylene glycol methacrylate, and methoxydiethylene glycol methacrylate. These may be used independently, or in combination. Among them, styrene and butyl acrylate are particularly preferable because they are readily available, and have an excellent charging ability.

Moreover, the vinyl resin for use in the present invention may contain a compound containing a vinyl polymerizable functional group and an acid group (may referred to as “acid monomer” hereinafter) in an amount of 0% by mass to 7% by mass relative to the monomer mixture. The amount of the acid monomer is preferably 0% by mass to 4% by mass, more preferably no acid monomer is used. When the amount of the acid monomer is larger than 7% by mass, the obtained vinyl resin particles have high dispersed stability themselves, so that they are hardly deposited on or easily detached from oil droplets after the deposition at normal temperature even these vinyl resin particles are added to a dispersion liquid in which the oil droplets are dispersed in an aqueous phase. The vinyl resin particles are therefore easily detached during the processes of removal of the solvent, washing, drying and external additive treatment. When the amount of the acid monomer is 4% by mass or smaller, the resulting toner can have no or only a small change in the charging ability thereof with respect to the change in the environment for use.

Examples of the acid group contained in the compound containing a vinyl polymerizable functional group and an acid group include carboxylic acid, sulfonic acid, and phosphonic acid.

Examples of the compound containing a vinyl polymerizable functional group and an acid group include a carboxyl group-containing vinyl monomer or a salt thereof (e.g., (meth)acrylic acid, maleic acid (anhydride), monoalkyl maleate, fumaric acid, monoalkyl fumarate, crotonic acid, itaconic acid, monoalkyl itaconate, itaconic acid glycol monoether, citraconic acid, monoalkyl citraconate, and cinnamic acid), a sulfonic acid group-containing vinyl monomer, a vinyl sulfuric acid monoester or a salt thereof, and a phosphoric acid group-containing vinyl monomer or a salt thereof. These may be used independently, or in combination. Among them, (meth)acrylic acid, maleic acid (anhydride), monoalkyl maleate, fumaric acid, and monoalkyl fumarate are preferable.

In the case where the vinyl resin particles and the resin for forming the core have high compatibility, a desirable surface condition of the toner may not be obtained. The monomer mixture for use and the resin for forming the core can be therefore controlled to have the polarity or structure to reduce the compatibility thereof.

The solubility of the vinyl resin particles to an organic solvent for use is controlled so as not to dissolve the vinyl resin particles with the organic solvent more than necessary. In the case where the vinyl resin particles are dissolved to the extent where the particle shapes thereof cannot be maintained, the desirable surface condition of the toner may not be obtained.

A method for forming the vinyl resin particles is appropriately selected depending on the intended purpose without any restriction, and examples thereof include the following (a) to (f).

(a) The monomer mixture is reacted by a polymerization reaction such as a suspension polymerization method, an emulsification polymerization method, a seed polymerization method, and a dispersion polymerization method, to thereby produce a dispersion liquid of vinyl resin particles.
(b) The monomer mixture is polymerized in advance, and the obtained resin is pulverized by means of a mechanical rotating or jet pulverizer, followed by subjected to classification to thereby produce resin particles.
(c) The monomer mixture is polymerized in advance, the obtained resin is dissolved in a solvent to prepare a resin solution, and the resin solution is sprayed in the state of mist to thereby produce resin particles.
(d) The monomer mixture is polymerized in advance, and a solvent is added to a resin solution in which the obtained resin is dissolved in a solvent to precipitate resin particles. Alternatively, the obtained resin is dissolved in a heated solvent, and the resulted resin solution is cooled to thereby precipitate resin particles. Thereafter, the solvent is removed, to thereby produce resin particles.
(e) The monomer mixture is polymerized in advance, the obtained resin is dissolved in a solvent to prepare a resin solution, and the resin solution is dispersed in an aqueous medium in presence of an appropriate disperser, followed by removing the solvent by heating or reducing the pressure.
(f) The monomer mixture is polymerized in advance, the obtained resin is dissolved in a solvent to prepare a resin solution, and after dissolving an appropriate emulsifier in the resin solution, water is added to the resin solution to thereby proceed to phase transfer emulsification.

Among them, the method of (a) listed above is preferable because the operations of the production are easy, and the resin particles are smoothly applied to the following step as the resin particles is obtained as a dispersion liquid.

When the polymerization is carried out in the method of (a), a dispersion stabilizer is added to the aqueous medium, or a monomer (so called a reactive emulsifier) capable of giving dispersion stability to the resin particles obtained by the polymerization is added to the monomer subjected to the polymerization reaction, or the both preceding methods are used in combination to thereby provide dispersion stability to the resulting vinyl resin particles. Without the dispersion stabilizer or reactive emulsifier, a vinyl resin may not be obtained as particles as the dispersion state of the particles cannot be maintained, or the resin particles may be arrogated to each other during storage as the obtained resin particles has poor storage stability due to low dispersion stability, or the uniformity in the diameters, shapes or surface conditions of the resulting toner may be poor as the dispersion stability of the particles are insufficient in the resin particles deposition step described later, which tends to cause aggregation or fusion of the core particles. Accordingly, the aforementioned method without use of the dispersion stabilizer or reactive emulsifier is not preferable.

Examples of the dispersion stabilizer include a surfactant and an inorganic disperser.

Examples of the surfactant include: anionic surfactants such as alkylbenzenesulfonic acid salts, α-olefin sulfonic acid salts and phosphoric acid esters; amine salts such as alkyl amine salts, amino alcohol fatty acid derivatives, polyamine fatty acid derivatives and imidazoline; quaternary ammonium salt cationic surfactants such as alkyltrimethylammonium salts, dialkyldimethylammonium salts, alkyl dimethyl benzyl ammonium salts, pyridinium salts, alkyl isoquinolinium salts and benzethonium chloride; nonionic surfactants such as fatty acid amide derivatives and polyhydric alcohol derivatives; and amphoteric surfactants such as alanine, dodecyldi(aminoethyl)glycine, di(octylaminoethyl)glycine and N-alkyl-N,N-dimethylammonium betaine. These may be used independently, or in combination.

Examples of the inorganic dispersant include tricalcium phosphate, calcium carbonate, titanium oxide, colloidal silica, and hydroxyapatite.

During the production of the resin particles, a commonly used chain transfer agent may be used for the purpose of adjusting the molecular weight.

The chain transfer agent is appropriately selected depending on the intended purpose without any restriction, and as for the chain transfer agent, a C3 or higher hydrocarbon group-containing alkylmercaptan-based chain transfer agent is preferably used. The C3 or higher hydrocarbon group-containing alkylmercaptan-based hydrophobic chain transfer agent is appropriately selected depending on the intended purpose without any restriction, and examples thereof include butanethiol, octanethiol, decanethiol, dodecanethiol, hexadecanethiol, octadecanethiol, cyclohexylmercaptan, thiophenol, octyl thioglycolate, octyl-2-mercaptopropionate, octyl-3-mercaptopropionate, 2-ethylhexyl mercaptopropionate, 2-mercaptoethyl octanoate, 1,8-dimercapto-3,6-dioxaoctane, decanetrithiol, and dodecylmercaptan. These may be used independently, or in combination.

An amount of the chain transfer agent is appropriately selected depending on the intended purpose without any restriction, provided that the resulting copolymerization product can be controlled to have a desired molecular weight. The amount thereof is preferably 0.01 parts by mass to 30 parts by mass, more preferably 0.1 parts by mass to 25 parts by mass, relative to the total moles of the monomer component. When the amount of the chain transfer agent is smaller than 0.01 parts by mass, the molecular weight of the resulting copolymerization product is large, which may cause low fixing ability of the resulting toner, or may cause gelation during the polymerization reaction. When the amount of the chain transfer agent is larger than 30 parts by mass, the chain transfer agent remains without being reacted, and the molecular weight of the resulting copolymerization product is small, which may cause depositions on members of a device.

The weight average molecular weight of the vinyl resin is preferably 3,000 to 300,000, more preferably 4,000 to 100,000, and even more preferably 5,000 to 50,000. When the weight average molecular weight thereof is smaller than 3,000, mechanical strength of the vinyl resin is weak and the vinyl resin is brittle, and hence the surface of the resulting toner may easily change depending on the application or using condition of the toner, which may cause, for example, significant change in the charging ability of the toner, contamination such as deposition of the toner on the surrounding members, or quality problems along with the problems as mentioned. Therefore, use of the vinyl resin having such weight average molecular weight is not preferable. When the weight average molecular weight thereof is larger than 300,000, the number of the terminals of the molecules is small, and hence there is less chance for the vinyl resin to interlock with a molecular chain of the core particle, which may reduce an ability of depositing onto the core particle.

The glass transition temperature (Tg) of the vinyl resin is preferably 40° C. or higher, more preferably 50° C. or higher, and even more preferably 60° C. or higher. When the glass transition temperature thereof is lower than 40° C., the resulting toner may have a problem in storage stability such as causing blocking when stored at a high temperature.

### <Colorant>

The colorant is appropriately selected depending on the intended purpose without any restriction, and examples thereof include carbon black, a nigrosin dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G, R), tartrazinelake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro anilin red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red F5R, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS and BC), indigo, ultramarine, iron blue, anthraquinone blue, fast violet B, methyl violet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, and lithopone. These may be used independently, or in combination.

An amount of the colorant is preferably 1% by mass to 15% by mass, more preferably 3% by mass to 10% by mass, relative to the toner.

### <Releasing Agent>

The releasing agent is appropriately selected depending on the intended purpose without any restriction, and examples thereof include polyolefin wax (e.g., polyethylene wax and polypropylene wax); long-chain hydrocarbon (e.g., paraffin wax, Fischer-Tropsch wax, and Sasol wax); and wax containing a carbonyl group.

Examples of the wax containing a carbonyl group include polyalkanoic acid esters such as carnauba wax, montan wax, trimethylol propane tribehenate, pentaerythritol tetrabehenate, pentaerythritol diacetate dibehenate, glycerin tribehenate, and 1,18-octadecanediol distearate; polyalkanol esters such as tristearyl trimellitate, and distearyl maleate; polyalkanoic acid amides such as ethylene diamine dibehenyl amide; polyalkyl amide such as trimellitic acid tristearyl amide; and dialkyl ketone such as distearyl ketone. These may be used independently, or in combination. Among them, polyolefin wax and long-chain hydrocarbon are preferable because of their small polarity and low melt viscosity, and paraffin wax and Fischer-Tropsch wax are particularly preferable.

An amount of the releasing agent is preferably 4 parts by mass to 15 parts by mass, more preferably 5 parts by mass to 10 parts by mass, relative to 100 parts by mass of the binder resin. When the amount of the releasing agent is smaller than 4 parts by mass, the releasing property of the toner cannot be secured against the fixing unit, which may cause offset, leading to occurrences of image failure. When the amount thereof is larger than 15 parts by mass, a large amount of the releasing agent is present on a surface of the toner particle, which may contaminate the developing unit, leading to occurrences of image failure where the contaminated portion appears as white blank in the image.

### <Production Method of Toner>

The production method of the toner of the present invention will be described with examples hereinafter, but the production method thereof is not limited to these examples.

### <<Core Particle (Main Part) Granulation Step>>

The organic solvent used in the granulation is preferably volatile, and has a boiling point of lower than 100° C., as the removal of the solvent in the later step becomes easy.

Examples of the organic solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These may be used independently, or in combination. Among them, the ester solvent such as methyl acetate, and ethyl acetate; the aromatic solvent such as toluene, and xylene; and halogenated hydrocarbon such as methylene chloride, 1,2-dichloroethane, chloroform, and carbon tetrachloride are preferable.

The polyester resin and the colorant may be dissolved or dispersed together, but they are generally separately dissolved or dispersed. An organic solvent used for the dissolving or dispersing the polyester resin and an organic solvent for the colorant may be different or identical, but it is preferred that the identical organic solvent be used in view of the removal of the solvent performed later. When a solvent (alone or a mixture) to which the polyester resin is suitably dissolved is selected, a releasing agent suitably used in the present invention is hardly dissolved in the solvent due to a difference in the solubility.

A solution or dispersion liquid of the polyester resin preferably has a resin concentration of about 40% by mass to about 80% by mass. When the resin concentration thereof is too high, the dissolving or dispersing is difficult, and the resulting solution or dispersion liquid is difficult to handle because of its high viscosity. When the resin concentration thereof is too low, the yield of the particles becomes small, and the amount of the solvent to be removed becomes large. In the case where the modified polyester resin containing an isocyanate group at a terminal thereof is mixed with the polyester resin, the modified polyester resin may be mixed in the same solution or dispersion solution of the polyester resin, or a solution or dispersion liquid of a modified polyester resin may be separately produced. In view of the solubility and viscosities of the polyester resin and the modified polyester resin, it is preferred that solutions or dispersion liquids be separately produced.

### —Aqueous Medium—

The aqueous medium is appropriately selected depending on the intended purpose without any restriction, and for example, water is used alone, or in combination with a solvent miscible with water.

Examples of the solvent miscible with water include alcohol (e.g., methanol, isopropanol, and ethylene glycol), dimethylformamide, tetrahydrofuran, cellosolves (e.g. methyl cellosolve), and lower ketones (e.g. acetone, and methyl ethyl ketone).

An amount of the aqueous medium is preferably 50 parts by mass to 2,000 parts by mass, more preferably 100 parts by mass to 1,000 parts by mass, relative to 100 parts by mass of the resin particles.

When the solution or dispersion liquid of the polyester resin and the releasing agent is dispersed in the aqueous medium, an inorganic dispersant or organic resin particles are preferably dispersed in the aqueous medium in advance so that the dispersion state is stabilized as well as giving a sharp particle size distribution.

Examples of the inorganic dispersant include tricalcium phosphate, calcium carbonate, titanium oxide, colloidal silica, and hydroxyapatite.

As for the resin for forming the organic resin particles, any resin can be used provided that it is capable of forming an aqueous dispersion liquid, and may be a thermoplastic resin or a thermoset resin. Examples of the resin include a vinyl resin, a polyurethane resin, an epoxy resin, a polyester resin, a polyamide resin, a polyimide resin, a silicon-based resin, a phenol resin, a melamine resin, a urea resin, an aniline resin, an iomer resin, and a poly carbonate resin. These may be used independently, or in combination. Among them, the vinyl resin, polyurethane resin, epoxy resin, polyester resin, and the combination thereof are preferable because it is easy using the preceding resins to form an aqueous dispersion liquid of fine spherical resin particles.

Moreover, a surfactant is optionally used during the production of the resin particles.

Examples of the surfactant include: anionic surfactants such as alkylbenzenesulfonic acid salts, α-olefin sulfonic acid salts and phosphoric acid esters; amine salts such as alkyl amine salts, amino alcohol fatty acid derivatives, polyamine fatty acid derivatives and imidazoline; quaternary ammonium salt cationic surfactants such as alkyltrimethylammonium salts, dialkyldimethylammonium salts, alkyl dimethyl benzyl ammonium salts, pyridinium salts, alkyl isoquinolinium salts and benzethonium chloride; nonionic surfactants such as fatty acid amide derivatives and polyhydric alcohol derivatives; and amphoteric surfactants such as alanine, dodecyldi(aminoethyl)glycine, di(octylaminoethyl)glycine and N-alkyl-N,N-dimethylammonium betaine.

Also, a fluoroalkyl group-containing surfactant can exhibit its dispersing effects even in a small amount.

Examples of the anionic surfactant containing a fluoroalkyl group include C2-C10 fluoroalkyl carboxylic acid or a metal salt thereof, disodium perfluorooctanesulfonylglutamate, sodium 3-[ω-fluoroalkyl(C6-C11)oxy)-1-alkyl(C3-C4) sulfonate, sodium 3-ω-fluoroalkanoyl(C6-C8)-N-ethylamino]-1-propanesulfonate, fluoroalkyl(C11-C20) carboxylic acid or a metal salt thereof, perfluoroalkylcarboxylic acid(C7-C13) or a metal salt thereof, perfluoroalkyl(C4-C12)sulfonate or a metal salt thereof, perfluorooctanesulfonic acid diethanol amide, N-propyl-N-(2-hydroxyethyl)perfluorooctanesulfone amide, perfluoroalkyl(C6-C10)sulfoneamidepropyltrimethylammonium salt, a salt of perfluoroalkyl(C6-C10)-N-ethylsulfonylglycin and monoperfluoroalkyl(C6-C16) ethylphosphate. Examples of the cationic surfactant include an aliphatic primary, secondary or tertiary amine acid containing a fluoroalkyl group, aliphatic quaternary ammonium salt such as perfluoroalkyl(C6-C10)sulfonic amide propyl trimethyl ammonium salt, benzalkonium salt, benzetonium chloride, pyridinium salt and imidazolinium salt.

Moreover, the dispersed droplets may be stabilized with a polymer protective colloid.

Examples of the polymer protective colloid include: acids such as acrylic acid, methacrylic acid, α-cyanoacrylic acid, α-cyanomethacrylic acid, itaconic acid, crotonic acid, fumaric acid, maleic acid and maleic anhydride; a (meth)acryl monomer containing a hydroxyl group, such as β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylic acid esters, diethylene glycol monomethacrylic acid esters, glycerin monoacrylic acid esters, glycerin monomethacrylic acid esters, N-methylolacrylamide and N-methylolmethacrylamide; vinyl alcohol or ether of vinyl alcohol, such as vinyl methyl ether, vinyl ethyl ether, and vinyl propyl ether; ester of vinyl alcohol and a compound containing a carboxyl group, such as vinyl acetate, vinyl propionate and vinyl butyrate; acrylamide, methacrylamide, diacetone acrylamide and a methylol compound; acid chloride such as acrylic acid chloride and methacrylic acid chloride; homopolymer or copolymer of those containing a nitrogen atom or heterocycle, such as vinyl pyridine, vinyl pyrrolidone, vinyl imidazole and ethyleneimine; polyoxyethylene such as polyoxyethylene, polyoxypropylene, polyoxyethylene alkylamine, polyoxypropylene alkylamine, polyoxyethylene alkylamide, polyoxypropylene alkylamide, polyoxyethylene nonylphenyl ether, polyoxyethylene laurylphenyl ether, polyoxyethylene stearylphenyl ester, and polyoxyethylene nonylphenyl ester; and cellulose such as methyl cellulose, hydroxyl ethyl cellulose, and hydroxyl propyl cellulose.

In the case where a compound that can be dissolved in acid and alkali, such as calcium phosphate is used as the dispersion stabilizer, after dissolving calcium phosphate using an acid such as hydrochloric acid, removing calcium phosphate from the particles by a method such as washing with water. Althernatively, the dispersion stabilizer can be removed by decomposing with an enzyme. When the dispersant is used, the dispersant can be left on the surfaces of the toner particles, but it is preferably removed by washing in view of the charging ability of the resulting toner.

The dispersion method is not particularly restricted, but the conventional equipment, such as a low-speed shearing disperser, a high-speed shearing disperser, a friction disperser, a high-pressure jetting disperser and ultrasonic wave disperser can be used. In the case where the high-speed shearing disperser is used, the rotating speed is not particularly restricted, but it is preferably 1,000 rpm to 30,000 rpm, more preferably 5,000 rpm to 20,000 rpm. The temperature during dispersing is typically 0° C. to 150° C. (under pressure), preferably 20° C. to 80° C.

### <Oil Phase Production Step>

As for a method for producing an oil phase in which the resin, the colorant, and the releasing agent are dissolved or dispersed in an organic solvent, there are a method in which materials such as the resin, and the colorant are gradually added to an organic solvent with stirring, to dissolve or disperse the materials in the organic solvent. In the case where a pigment is used as the colorant, or there is a material, such as a releasing agent and a charge controlling agent, which is hardly dissolved in an organic solvent, it is preferred that particles thereof be treated to reduce their size before added to the organic solvent.

As mentioned above, forming a master batch of the colorant is one of the methods, and the same method can be applied to the releasing agent or charge controlling agent.

As another method, a dispersing agent is optionally added to the organic solvent, and the colorant, the releasing agent, and the charge controlling agent are dispersed in a wet system to obtain a wet master.

As yet another method, a dispersing agent is optionally added to the organic solvent, in the case where the materials (dispersoid) are dissolved at the temperature lower than the boiling point of the organic solvent, the organic solvent is heated and stirred together with the dispersoid to dissolve the dispersoid, and the solution is cooled with stirring or applying shear force to proceed to crystallization, to thereby generate microcrystal of the dispersoid.

The colorant, releasing agent, and charge controlling agent dispersed by the method mentioned above are dissolved or dispersed in the organic solvent together with the resin, and may be further subjected to dispersing. For the dispersing, a conventional disperser such as a bead mill and a disk mill can be used.

### <Core Particle Production Step>

A method for dispersing the oil phase obtained in the aforementioned step in the aqueous medium and producing a dispersion liquid in which core particles formed of the oil phase are dispersed is not particularly restricted, but the conventional equipment, such as a low-speed shearing disperser, a high-speed shearing disperser, a friction disperser, a high-pressure jetting disperser and ultrasonic wave disperser can be used. In order to give the dispersed elements particle diameters of 2 μm to 20 μm, use of a high-speed shearing disperser is preferable. In the case where the high-speed shearing disperser is used, the rotating speed is not particularly restricted, but it is typically 1,000 rpm to 30,000 rpm, preferably 5,000 rpm to 20,000 rpm. The duration for the dispersing is not particularly restricted, but it is typically 0.1 minutes to 5 minutes in case of the batch system. When the dispersing is performed for the period longer than 5 minutes, undesirable particles having small diameters may be remained, the dispersing makes the dispersion liquid in the over dispersed state, which makes the dispersion liquid unstable or causes aggregations or forms coarse particles. It is therefore not preferable. The temperature for the dispersing is typically 0° C. to 40° C., preferably 10° C. to 30° C. When the temperature is higher than 40° C., the dispersion stability is impaired as the molecular motions are activated, which may cause aggregations, or form coarse particles. It is therefore not preferable. When the temperature is lower than 0° C., the viscosity of the dispersion liquid increases, the shear force energy required for the dispersing increases, and hence the production efficiency decreases.

As for the surfactant, those described in the descriptions of the production method of the resin particles can be used, but it is preferably disulfonic acid salts having relatively high HLB for efficiently dispersing the oil droplets containing the solvent. A concentration of the surfactant in the aqueous medium is 1% by mass to 10% by mass, preferably 2% by mass to 8% by mass, and even more preferably 3% by mass to 7% by mass. When the concentration thereof is higher than 10% by mass, it is not preferable because the size of the resulting oil droplets may be small, or a reversed micelle structure is formed, which reduces the dispersion stability, and leads to the formation of coarse particles of the oil droplets. When the concentration thereof is lower than 1% by mass, it is not preferable because the oil droplets cannot be stably dispersed to thereby form coarse particles of the oil droplets.

### <Deposition Step of Resin Particles for Shell Layer>

The obtained core particle dispersion liquid can stably maintain droplets of the core particles as long as it is being stirred. In this state, the aforementioned vinyl resin particle dispersion liquid is added to the core particle dispersion liquid to thereby deposit the vinyl resin particles on the core particles. It is preferred that the vinyl resin particle dispersion liquid be added over a period of 30 seconds or longer. When it is added over the period shorter than 30 seconds, it is not preferable because aggregated particles may be formed as the dispersion system is suddenly changed, or the vinyl resin particles may not be uniformly deposited. When it is added over the excessively long period, e.g., longer than 60 minutes, it is not preferable in view of the production efficiency.

The resin particle dispersion liquid may be diluted or concentrated before added to the core particle dispersion liquid, for the purpose of appropriately adjusting the concentration thereof. The concentration of the vinyl resin particle dispersion liquid is preferably 5% by mass to 30% by mass, more preferably 8% by mass to 20% by mass. When the concentration thereof is lower than 5% by mass, it is not preferable because the resin particles may not be sufficiently deposited as the change in the organic solvent concentration due to the adding of the dispersion liquid is large. When the concentration thereof is higher than 30% by mass, the resin particles tend to be unevenly distributed in the core particle dispersion liquid, and as a result, the resin particles are unevenly deposited. Therefore, it is desirable to avoid such the concentration range.

The reason why the resin particles are adhered to the core particles with the sufficient strength according to the method of the present invention is because the core particles can freely changes their shapes when the resin particles are deposited on the droplets of the core particles and therefore the contacting area of the core particles with the interface with the resin particles can be sufficiently secured, and the organic solvent makes the resin particles swollen or dissolved to thereby form the resin particles into the state where the resin particles are easily adhered to the resin contained in the core particles. Accordingly, in this state, it is important that the organic solvent is present in the sufficient amount within the system. Specifically, the amount of the organic solvent is 10% by mass to 70% by mass, preferably 30% by mass to 60% by mass, and even more preferably 40% by mass to 55% by mass, relative to the solid content (e.g., the resin, and the colorant, and optionally the releasing agent, and the charge controlling agent) in the core particle dispersion liquid. When the amount thereof is larger than 70% by mass, it is not preferable because the yield of the color resin particles obtained in one operation of the production is low, and therefore the production efficiency is low, and moreover it is difficult to carry out the stable operation of the production when the amount of the organic solvent is large, as the dispersion stability is low, which may cause reaggregation. When the amount thereof is smaller than 10%, it is not preferable because the resin particles cannot be adhere to the core particles with the sufficient strength as mentioned above. In the case where the preferable organic solvent concentration at the time when the resin particles are deposited is lower than the preferable organic solvent concentration during the production of the core particles, the organic solvent concentration may be adjusted after producing the core particles, by partially removing the organic solvent, and then the resin particles are deposited, followed by removing the organic solvent completely. Note that, the removing the organic solvent completely is to remove the organic solvent to the level which can be removed by the generally used conventional method in the step of removal of the solvent described later.

The temperature when the vinyl resin particles are deposited on the core particles is preferably 10° C. to 60° C., more preferably 20° C. to 45° C. When the temperature is higher than 60° C., it is not preferable because environmental loads from the production increase as the energy required for the production increases, and the dispersion state becomes unstable as the vinyl resin particles having low acid value present on the surfaces of droplets, which may cause formation of coarse particles. When the temperature is lower than 10° C., it is not preferable because the viscosity of the dispersion liquid becomes high, and resin particles are not sufficiently deposited.

### <Removal of Solvent>

In order to remove the organic solvent from the obtained color resin dispersion liquid, a conventional method can be used. For example, a method in which the temperature, of the entire system is gradually increased under normal pressure or reduced pressure to completely evaporate and remove the organic solvent from the droplets can be used.

<Elongation and/or Crosslink Reaction>

In the case where a modified polyester resin containing an isocyanate group at a terminal thereof and amines reactive with the modified resin are added for the purpose of introducing the modified polyester resin containing an urethane and/or urea group, the amines may be mixed in the oil phase before the toner materials are dispersed in the aqueous medium, or the amines may be added to the aqueous medium. The duration for the reaction is selected depending on the reactivity between the isocyanate group contained in the polyester prepolymer and the added amines, but it is typically 1 minute to 40 hours, preferably 1 hour to 24 hours. The reaction temperature is typically 0° C. to 150° C., preferably 20° C. to 98° C.

### <Washing and Drying Step>

A conventional technique is used for a step for washing and drying the toner particles dispersed in the aqueous medium.

Specifically, after performing solid-liquid separation by means of a centrifugal separator or filter press, the obtained toner cake is again dispersed in an ion-exchanged water having the temperature in the range of normal temperature to about 40° C., optionally followed by adjusting the pH with acid or alkali, and then solid-liquid separation is again performed. This series of operations are repeated a few times to thereby remove impurities and the surfactant, the resultant is dried by a flash dryer, a circulating dryer, a vacuum dryer, or a vibration flow dryer to thereby obtain toner particles. During this operation, small particles of the toner may be removed by centrifugal separation. Alternatively, classification may be performed by means of a classification device after the drying to obtain a desired particle size distribution of the toner.

### <External Additive Treatment>

As for the specific method for adding the silicone oil-treated external additive and other external additives to the obtained and dried toner particles, there are a method in which an impact is applied to a mixture using a high-speed rotating blade, and a method in which an impact is applied by putting mixed particles into a high-speed air flow and accelerating the air speed so that the particles collide against one another or that the particles are crashed into a proper collision plate. Examples of apparatuses used in these methods include ANGMILL (product of Hosokawa Micron Corporation), an apparatus produced by modifying I-type mill (product of Nippon Pneumatic Mfg. Co., Ltd.) so that the pulverizing air pressure thereof is decreased, a hybridization system (product of Nara Machinery Co., Ltd.), a kryptron system (product of Kawasaki Heavy Industries, Ltd.) and an automatic mortar.

The volume average particle diameter of the toner is preferably 3 μm to 9 μm, more preferably 4 μm to 8 μm, and even more preferably 4 μm to 7 μm, in order to provide an inexpensive electrophotographic system providing images of excellent image quality using the toner of the present invention. When the volume average particle diameter thereof is smaller than 3 μm, the adhesion force of the toner relatively increases, the operatability of the toner reduces in the electric field, and therefore it is difficult to perform cleaning using an inexpensive blade. Accordingly, use of the toner having the volume average particle diameter of smaller than 3 μm is not preferable. When the volume average particle diameter of the toner is larger than 9 μm, image quality of the resulting images, such as reproducibility of fine lines, is low.

Moreover, the ratio (volume average particle diameter/number average particle diameter) of the volume average particle diameter of the toner to the number average particle diameter of the toner is preferably 1.25 or lower, more preferably 1.20 or lower, and even more preferably 1.17 or lower. When the ratio thereof is higher than 1.25, the toner of the large particle diameters, or of the small particle diameters in some cases, may be consumed by repeated printing, and the average particle diameter of the toner remained in the developing unit changes, which may lead to a change in an optimal developing conditions for developing with the remained toner. As a result, various problems tend to occur, such as charging failures, significant increase or decrease in the transporting amount of the toner, toner clogging, and dropping of the toner.

The particle size distribution of the toner can be measured by a coulter counter method, and examples of the measuring device for use include Coulter Counter TA-II and Coulter Multisizer II (both manufactured by Beckman Coulter, Inc.).

The average circularity of the toner is appropriately selected depending on the intended purpose without any restriction, but it is 0.96 to 1, and preferably 0.97 to 0.98. When the average circularity is less than 0.96, sufficient transfer ability of the toner, or high quality images without depositions may not be attained.

The average circularity of the toner can be measured by the following method.

The value obtained from the following equation (1) is determined as circularity a. This circularity is a factor for indicating the surface irregularities of the toner particles, and is 1.00 when the toner particle is a complete sphere, and gives the smaller value when the surface structure thereof is more complicated.

Circularity a=L₀/L (1)

In the equation (1), L₀ is a length of a circumference of a circle having the same area to the projected area of the particle image, and L is a boundary length of the projection area of the particle.

The measurement method of the average circularity is explained next. The average circularity can be measured, for example, by means of a flow particle image analyzer FPIA-1000, manufactured by SYSMEX CORPORATION.

The specific measuring method is as follow. To 100 mL to 150 mL of water contained in a container, from which impurity solids have been removed in advance, 0.1 mL to 0.5 mL of a surfactant as a dispersant, preferably alkyl benzene sulfonic acid salt, is added, and about 0.1 g to about 0.5 g of a sample is further added. The resulting suspension liquid in which the sample has been dispersed is subjected to a dispersion treatment by means of an ultrasonic wave disperser for about 1 minute to about 3 minutes, followed by measuring the shapes and particle size of the toner by means of the device with the dispersion liquid concentration of 3,000 particles/μL to 10,000 particles/μL.

### (Image Forming Apparatus)

The image forming apparatus of the present invention forms an image using the toner of the present invention. Note that, the toner of the present invention can be used for either a one-component developer or a two-component developer, but it is preferred that the toner of the present invention be used as a one-component developer.

The image forming apparatus of the present invention preferably has an endless intermediate transfer unit.

The image forming apparatus of the present invention preferably contains a latent image bearing member, and a cleaning unit configured to clean the toner remained on the latent image bearing member and/or the intermediate transfer unit. The cleaning unit may contain a cleaning blade, or may not contain a cleaning blade.

Moreover, the image forming apparatus of the present invention preferably contains a fixing unit configured to fix an image using a roller containing a heating device or a belt containing a heating device. Further, the image forming apparatus of the present invention preferably contains a fixing unit, which does not need to apply oil to a fixing member. The image forming apparatus of the present invention preferably further contains appropriately selected other unit, e.g., a diselectrification unit, a recycling unit, and a controlling unit, if necessary.

The image forming apparatus of the present invention contains constitutional elements such as a latent image bearing member, a developing unit, and a cleaning unit, as a process cartridge, and the process cartridge may be detachably mounted in a main body of the image forming apparatus. Moreover, at least one selected from the group consisting of a charging unit, an exposing unit, a developing unit, a transferring unit, a separating unit, and a cleaning unit is supported together with a latent image bearing member to constitute a process cartridge, and the image forming apparatus has a structure where the process cartridge is as a single unit detachably mounted in the main body of the image forming apparatus using a guiding unit such as a rail provided in the main body of the image forming apparatus.

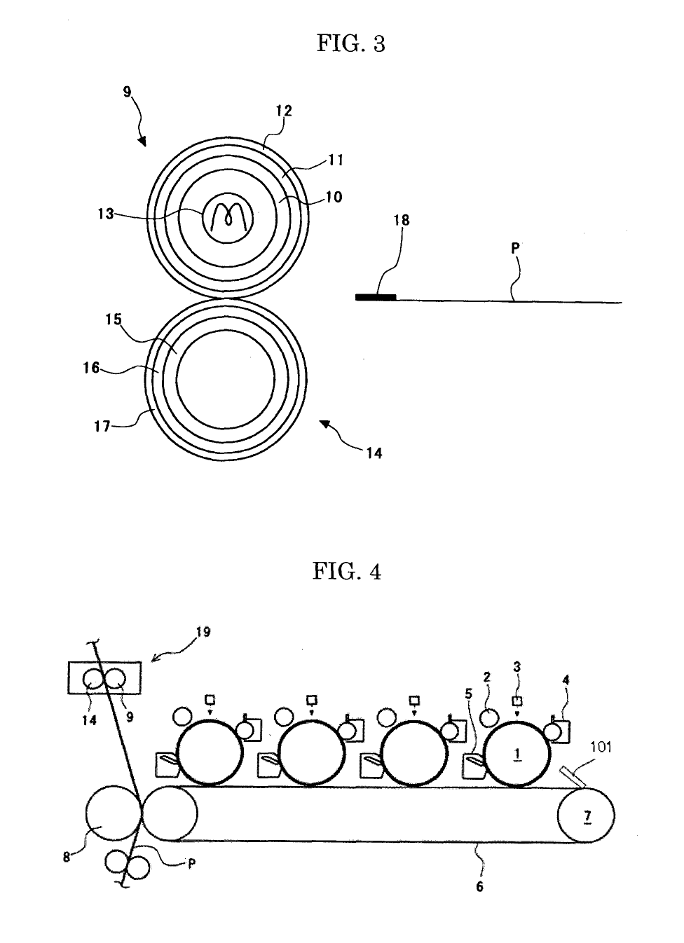

FIG. 2 illustrates one example of the image forming apparatus of the present invention. This image forming apparatus contains a latent image bearing member 1, which is driven to rotate in the clockwise direction in FIG. 2, and is housed in a casing of a main body not illustrated in the diagram. In the surrounding area of the latent image bearing member 1, a charging unit 2, an exposing unit 3, a developing unit 4 containing the toner T of the present invention, a cleaning unit 5, an intermediate transfer member 6, a support roller 7, a transfer roller 8, a diselectrification unit (not illustrated), and an intermediate transfer member cleaning blade 101 are provided.

This image forming apparatus is equipped with a paper feeding cassette (not illustrated) for storing a plurality of sheets of recording paper P as an example of the recording medium. The recording paper P in the paper feeding cassette is sent out one by one to enter between a transfer roller 8 and an intermediate transfer member 6 as the transferring unit after the timing for entering is adjusted by a pair of registration rollers, which are not illustrated.

This image forming apparatus is configured to drive the latent image bearing member 1 to rotate in the clockwise direction in FIG. 2, and uniformly charge the latent image bearing member 1 by the charging unit 2. Thereafter, laser light modulated based on the image data is applied to the latent image bearing member 1 by means of the exposing unit 3 to thereby form a latent electrostatic image on the latent image bearing member 1, and the toner is deposited on the latent image bearing member 1, on which the latent electrostatic image has been formed, by means of the developing unit 4 to thereby develop the latent electrostatic image. Next, the toner image formed by the developing unit 4 is transferred from the latent image bearing member 1 to the intermediate transfer member 6 by applying the transfer bias to the intermediate transfer member 6, and the toner image is then transferred from the intermediate transfer member 6 to the recording paper P by transporting the recording paper P to between the intermediate transfer member 6 and the transfer roller 8. The recording paper P on which the toner image has been transferred is then transported to a fixing unit (not illustrated).

The fixing unit is equipped with a fixing roller that is heated to the predetermined fixing temperature by a built-in heater, and a pressure roller which is configured to press against the fixing roller with the predetermined pressure. The fixing unit heats and presses the recording paper transported by the transfer roller 8 to fix the toner image on the recording paper, followed by output the recording paper onto a paper discharging tray (not illustrated).

Meanwhile, in the image forming apparatus, a latent image bearing member, from which the toner image has been transferred to the recording paper by the transfer roller 8, is further rotated, and the residual toner remained on the surface of the latent image bearing member 1 is removed by scraping with the cleaning unit 5, and then the latent image bearing member 1 is diselectrified by the diselectrification unit that is not illustrated. The image forming apparatus enters into the next image formation operation after uniformly charging the latent image bearing member 1, which has been diselectrified by the diselectrification unit, by the charging unit 2.

Members suitably used in the image forming apparatus of the present invention will be specifically explained hereinafter.

The material, shape, structure and size of the latent image bearing member 1 are appropriately selected from those known in the art without any restriction. Examples of the shape thereof include a drum, and a belt. Examples of the material thereof include: an inorganic latent image bearing member such as amorphous silicon, and selenium; and an organic latent image bearing member such as polysilane, and phthalopolymethine. Among them, the amorphous silicon and the organic latent image bearing member are preferable as they have a long service life.

Forming a latent electrostatic image on the latent image bearing member 1 can be performed, for example, by charging the surface of the latent image bearing member 1, followed by exposing the surface to light imagewise, and the forming can be performed by a latent electrostatic image forming unit. The latent electrostatic image forming unit is equipped with, for example, at least a charging unit 2 configured to charge the surface of the latent image bearing member 1, and an exposing unit 3 configured to expose the surface of the latent image bearing member 1 to light imagewise.

The charging can be performed, for example, by applying voltage onto a surface of the latent image bearing member 1 by means of a charging unit 2.

The charging unit 2 is appropriately selected depending on the intended purpose without any restriction, and examples thereof include conventional contact chargers known in the art equipped with conductive or semiconductive roller, brush, film, rubber blade, or the like, and conventional non-contact charger using corona discharge such as corotron and scorotron.

The shape of the charging unit 2 may be, other than a roller, a magnetic brush, or a far brush, and can be selected depending on the specifications and embodiment of the electrophotographic device. In the case of the magnetic brush, the magnetic brush uses various ferrite particles, for example Zn—Cu ferrite, as a charging member, and the magnetic brush contains a non-magnetic electric conductive sleeve for supporting the charging member, and a magnet roller provided inside the sleeve. In the case where the brush is used, for example, a far which has been treated to have electric conductivity using carbon, copper sulfide, metal or metal oxide is used as a material of the far, and the far brush is formed by winding this electric conductive-treated material around a metal or another core rod, which has been treated to have electric conductivity.

The charging unit 2 is not restricted to a contact charger as described above, but use of the contact charger is preferable as an image forming apparatus which reduces generation of ozone from the charger can be provided.

The exposing can be performed, for example, by exposing the surface of the latent image bearing member to light imagewise using an exposing unit 3. The exposing unit 3 is appropriately selected depending on the intended purpose without any restriction, provided that it is capable of exposing the surface of the latent image bearing member 1, which has been charged by the charging unit 2, to light imagewise to write an image to be formed. Examples of the exposing unit include various exposing devices such as a reproduction optical exposing device, a rod-lens array exposing device, a laser optical exposure device, and a liquid crystal shutter optical device.

The developing can be performed, for example, by developing the latent electrostatic image with the toner of the present invention by means of a developing unit 4. The developing unit 4 is appropriately selected from conventional developing units without any restriction, provided that it can perform developing using the toner of the present invention. For example, a developing unit having at least a developing device housing the toner of the present invention and capable of applying the toner to the latent electrostatic image in a contact or non-contact manner is preferably used.

As for the developing unit 4, a preferable embodiment is a developing unit containing a developing roller 40 that bears a toner on the peripheral surface thereof, rotates in contact with the latent image bearing member 1, and provides the toner to a latent electrostatic image formed on the latent image bearing member 1 to perform developing, and a this layer forming member 41 that is in contact with the peripheral surface of the developing roller 40 to level the toner on the developing roller 40 to thereby shape the deposited toner into a thin layer.

As for the developing roller 40, a metal roller, or an elastic roller is preferably used. The metal roller is appropriately selected depending on the intended purpose without any restriction, and examples thereof include an aluminum roller. A developing roller 40 having a certain friction coefficient can be relatively easily formed with a metal roller by subjecting the metal roller to a blast treatment. Specifically, a surface of an aluminum roller can be roughened by subjecting the roller to glass bead blasting. Use of such blasted roller as the developing roller enables to attain an appropriate deposition amount of the toner on the developing roller.

As for the elastic roller, a roller coated with an elastic rubber layer is used, and moreover a surface coating layer formed of a material which is easily charged to have a reverse polarity to that of the toner is provided on the surface of the elastic layer. The elastic rubber layer is set to have the hardness of 60 degrees or lower in JIS-A to prevent the deterioration of the toner due to the concentration of pressure at the contacting point with the thin layer forming member 41. The surface roughness Ra thereof is set to the range of 0.3 μm to 2.0 μm, and by doing so, a necessary amount of the toner is held on the surface thereof. The ohmic value of the elastic rubber layer is moreover set to the range of 10³Ω to 10¹⁰Ω because developing bias is applied to the developing roller 40 to form the electric field between the developing roller 40 and the latent image bearing member 1. The developing roller 40 rotates in the clockwise direction to transport the toner carried on the surface thereof to the position facing the thin layer forming member 41 and latent image bearing member 1.

The thin layer forming member 41 is provided in the position that is lower than the contact position of the supplying roller 42 with the developing roller 40. As for the thin layer forming member 41, a metal plate spring material, such as a stainless steel (SUS), and phosphor bronze, is used, and a free edge of the thin layer forming member is brought into contact with a surface of the developing roller 40 with the pressure of 10 N/m to 40 N/m. Therefore, the toner passing through the thin layer forming member with the pressure is leveled to a thin layer, and at the same time, receives electric charge due to frictional electrification. To the thin layer forming member 41, moreover, regulation bias is applied to assist the frictional electrification, and the regulation bias has the value offset to the developing bias in the same direction as the charging polarity of the toner.

The rubber elastic material for forming the surface of the developing roller 40 is appropriately selected depending on the intended purpose without any restriction, and examples thereof include styrene-butadiene copolymer rubber, acrylonitrile-butadiene copolymer rubber, acryl rubber, epichlorohydrin rubber, urethane rubber, silicone rubber, and a blending product of two or more from the preceding rubbers. Among them, the blended rubber of the epichlorohydrin rubber and the acrylonitrile-butadiene copolymer rubber is particularly preferable.

The developing roller 40 is produced, for example, by coating a peripheral surface of an electric conductive shaft with an elastic rubber material. The electric conductive shaft is, for example, formed of a metal such as stainless steel (SUS).

The transferring can be performed, for example, by charging the latent image bearing member 1, which can be performed by a transfer roller. As for the transfer roller, a preferable embodiment is to contain a primary transferring unit configured to transfer the toner image on the intermediate transfer member 6 to form a transfer image, and a secondary transferring unit (transfer roller 8) configured to transfer the transfer image onto recording paper P. The more preferable embodiment is that two or more color toners, preferably full color toners are used as the toner, and a primary transferring unit and a secondary transferring unit are contained, where the primary transferring unit is configured to transfer toner images onto the intermediate transfer member 6 to form a composite transfer image and the secondary transferring unit is configured to transfer the composite transfer image onto recording paper P.

The intermediate transfer member 6 is appropriately selected from conventional transfer members depending on the intended purpose without any restriction, and preferable examples thereof include a transfer belt.

The transferring unit (primary transferring unit, secondary transferring unit) preferably contains at least a transfer equipment configured to charge the toner image formed on the latent image bearing member 1 to release and transfer to the side of recording paper P. The number of the transferring units equipped may be one, or two or more. Examples of the transferring unit include a corona transfer device using corona discharge, a transfer belt, a transfer roller, a pressure transfer roller, and an adhesion transfer member.

The recording paper P is typically plain paper, but is appropriately selected depending on the intended purpose without any restriction, provided that an unfixed image after the developing can be transferred onto the recording paper. For example, a PET base for OHP can be also used as the recording paper P.

The fixing can be performed, for example, on the toner image transferred onto the recording paper P by means of a fixing unit. The fixing may be performed every time when a toner image of each color is transferred onto the recording paper P, or the fixing may be performed once on a laminate of toner images of all colors.

The fixing unit is appropriately selected depending on the intended purpose without any restriction, but a conventional heating pressurizing unit is suitable as the fixing unit. Examples of the heating and pressurizing unit include a combination of a heating roller and a pressure roller, and a combination of a heating roller, a pressure roller, and an endless belt. The heating temperature by the heating pressurizing unit is preferably 80° C. to 200° C.

The fixing unit may be a fixing device equipped with a soft roller containing a fluoro-surface layer forming agent, as illustrated in FIG. 3. The heating roller 9 contains an aluminum core rod 10, an elastic material layer 11 of silicone rubber on the aluminum core rod 10, and a surface layer 12 formed of tetrafluorothylene-co-perfluoro(alkyl vinyl ether) (PFA), and is equipped with a heater 13 inside the aluminum core rod. The pressure roller 14 contains an aluminum core rod 15, an elastic material layer 16 of silicone rubber on the aluminum core rod, and a PFA surface layer 17. Note that, the recording paper P on which the unfixed image 18 has been deposited is fed in the manner as illustrated.

In the present invention, for example, a conventional optical fixing unit may be used together with, or instead of the fixing unit.

The diselectrification can be performed, for example, by applying diselectrification bias to the latent image bearing member, and can be suitably performed by a diselectrification unit. The diselectrification unit is appropriately selected from the conventional diselectrification unit without any restriction, provided that it is capable of applying diselectrification bias to the latent image bearing member, and preferable examples thereof include a diselectrification lamp.

The cleaning can be suitably performed, for example, by removing the residual toner on the latent image bearing member by a cleaning unit. The cleaning unit is appropriately selected from the conventional cleaners without any restriction, provided that it is capable of removing the residual toner on the latent image bearing member. As for the cleaning unit, for example, a magnetic brush cleaner, an electrostatic brush cleaner, a magnetic roller cleaner, a blade cleaner, a brush cleaner, and a web cleaner are preferable.

In the present invention, blade cleaning is preferably performed as it uses the most inexpensive member.

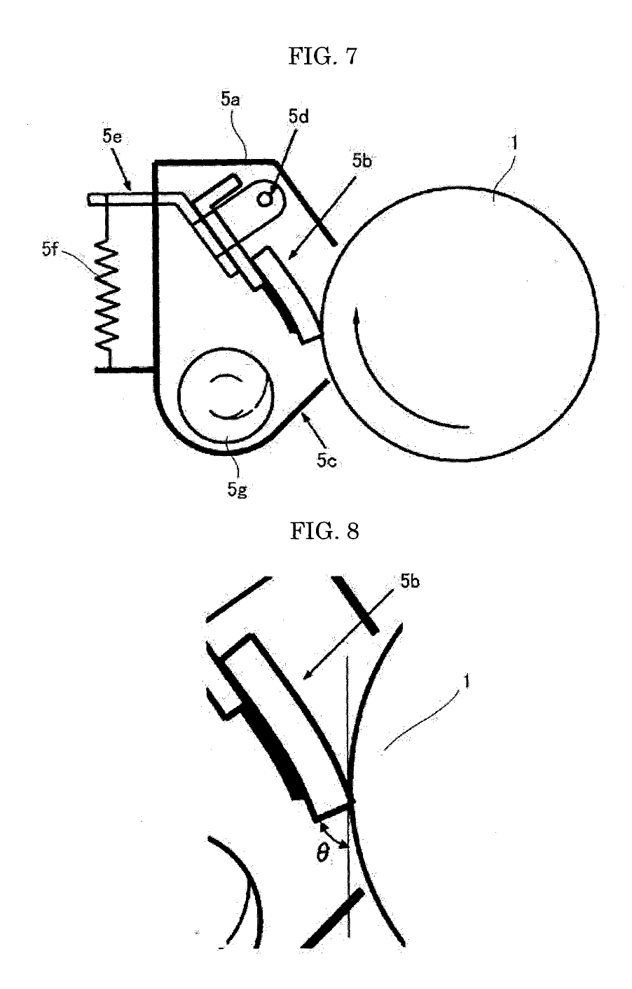

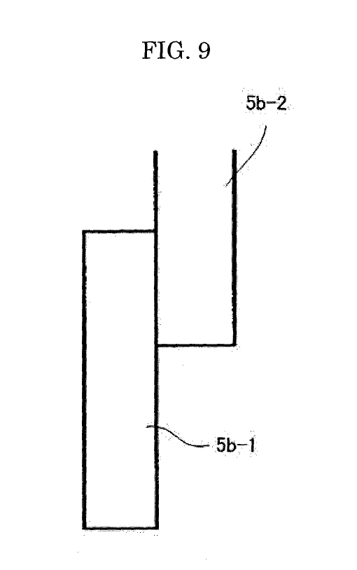

FIG. 7 is a diagram illustrating a cleaning unit 5 for use in the image forming apparatus of the present invention, FIG. 8 is a specific explanatory diagram of a cleaning unit, and FIG. 9 is a specific explanatory diagram of a cleaning blade.

In FIG. 7, the cleaning unit 5 used for cleaning the toner deposited on the surface of the latent image bearing member 1 is equipped with: a toner collecting case 5c; a moving member 5e supported by a rocking lever shaft 5b provided in the toner collecting case 5c, capable of rotating in the direction of the latent image bearing member 1, and capable of mounting a cleaning blade 5b thereon; and a tension spring 5f mounted on the opposite edge of the moving member 5e to the edge where the cleaning blade 5b is mounted taking the rocking lever shaft 5d as a center, and supplying torque to the moving member 5e and pressing force to the cleaning blade 5b, with which the cleaning blade 5b presses the latent image bearing member 1; and a screw 5g configured to transport the toner scraped from the surface of the latent image bearing member 1 by the contact of the cleaning blade 5b into the toner collecting case.

As illustrated in FIGS. 7 and 8, the cleaning blade 5b is constituted of a plate cleaning blade 5b-1 and a supporting member 5b-2 for supporting the plate cleaning blade 5b-1 as in FIG. 9, and the cleaning blade 5b is used by bringing the cleaning blade 5b-1 into contact with the surface of the latent image bearing member 1, which is rotated in the direction shown with the arrow (clockwise direction), with a certain contact angle θ by means of an energizing member such as a spring.

As for the material used for the cleaning blade 5b-1, a material having the hardness (JIS-A) of 60 degrees to 80 degrees, the elongation of 300% to 350%, the elongation set of 1.0% to 5.0%, the 300% modulus of 100 kg/cm² to 350 kg/cm², and the rebound resilience of 10% to 35% is used.

The material can be appropriately selected from the resins commonly used for a plate blade member, such as thermoplastic resin (e.g., a urethane resin, a styrene resin, an olefin resin, a vinyl chloride resin, a polyester resin, a polyamide resin, and a fluororesin. The lower friction coefficient of the cleaning blade is more preferable.

The material of the supporting member 5b-2 is appropriately selected depending on the intended purpose without any restriction, and examples thereof include a metal, plastic, and ceramic. Among them, a metal plate is preferable because a certain degree of force is applied to the supporting member, and a steel plate such as SUS, an aluminum plate, and a phosphor bronze plate are more preferable.

When the toner is used, the friction increases at the contact point between the cleaning blade 5b and the surface of the latent image bearing member 1 as the pressing force increases in the conventional blade cleaning system. As a result, the contact edge of the cleaning blade 5b may be caught in the rotational direction of the latent image bearing member along with the rotational motion of the latent image bearing member 1, which may cause the breakage of the cleaning blade 5b. In another case, the amplitude of the elasticity increases from the repeated reversion of the elasticity due to the compression caused by the catching of the cleaning blade by the latent image bearing member at least at the contact point, the coherency with the surface of the latent image bearing member decreases, which may cause cleaning failures by passing through the external additive, and the toner. From these reasons, the generation of the stopper layer is inhibited, which appears as noises on the resulting images. Accordingly, it is important to optimize the pressing force of the cleaning blade to the surface of the latent image bearing member, and to improve the performance of stopping and collecting the external additive, and the toner. In the present embodiment, the pressing force of 20 N/m to 50 N/m is applied to the cleaning blade.

At the same time, the contact angle is adjusted to be 70° to 82° so as not to disperse the force for preventing the external additive and the toner from passing through due to the increased contact area between the cleaning blade 5b and the surface of the latent image bearing member 1, and the contact angle is an angle formed between a tangent line at the contact point where the surface of the latent image bearing member 1 and the cleaning blade meets, and the plane of the cleaning blade 5b at the side of the latent image bearing member 1.

When the pressing force is increased, the elastic deformation of the cleaning blade 5b increases at the area adjacent to the contact point of the cleaning blade 5b and the latent image bearing member 1, and as a result, the contact area tends to increase. Since the contact angle is adjusted to 70° to 82° where the contact angle is the angle formed between a tangent line extended from the contact point at which the surface of the latent image bearing member 1 and the cleaning blade meets, and the plane of the edge of the cleaning blade 5b at the side of the latent image bearing member 1 (facing the surface of the latent image bearing member 1), the insufficient contact is inhibited, and a force for preventing the toner passing through, which has a sharp distribution, can be obtained from the applied pressing force.

Further, by maintaining the rebound resilience to the range of 10% to 35%, unevenness in the friction force generated in the length direction of the blade is responded by the elastic deformation, which enables to maintain the stable contact.

The recycling can be suitably performed, for example, by transporting the toner, which has been removed and collected by the cleaning unit, to the developing unit by a recycling unit. The recycling unit is appropriately selected depending on the intended purpose without any restriction, and examples thereof include a transporting unit.

The controlling can be suitably performed, for example, by controlling each unit by a controlling unit. The controlling unit is appropriately selected depending on the intended purpose without any restriction, provided that it is capable of controlling each device, and examples thereof include devices such as a sequencer, and a computer.

According to the image forming apparatus, image forming method, and process cartridge of the present invention, excellent images can be provided by using the toner of the present invention which has excellent fixing ability without cracking caused by stress from the developing process.

### <Multi-Color Image Forming Apparatus>

FIG. 4 is a schematic diagram illustrating one example of a multi-color image forming apparatus to which the present invention is applied. FIG. 4 illustrates a tandem full-color image forming apparatus.

In FIG. 4, the image forming apparatus contains a latent image bearing member 1 which is driven to rotate in the clockwise direction shown in the drawing, and is housed in a casing of a main body (not illustrated). In the surrounding area of the latent image bearing member 1, a charging unit 2, an exposing unit 3, a developing unit 4, an intermediate transfer member 6, a support roller 7, a transfer roller 8, and an intermediate transfer member cleaning blade 101 are provided. The image forming apparatus is equipped with a paper feeding cassette (not illustrated) for storing a plurality of sheets of recording paper. The recording paper P in the paper feeding cassette is sent out one by one to enter between a transfer roller 8 and an intermediate transfer member 6 as the transferring unit after the timing for entering is adjusted by a pair of registration rollers, which are not illustrated, followed by subjected to fixing by a fixing unit 19.

This image forming apparatus is configured to drive the latent image bearing member 1 to rotate in the clockwise direction in FIG. 4, and uniformly charge the latent image bearing member 1 by the charging unit 2. Thereafter, laser light modulated based on the image data is applied to the latent image bearing member 1 by means of the exposing unit 3 to thereby form a latent electrostatic image on the latent image bearing member 1, and the toner is deposited on the latent image bearing member 1, on which the latent electrostatic image has been formed, by means of the developing unit 4 to thereby develop the latent electrostatic image. In the image forming apparatus, the toner image formed by the developing unit 4 is transferred from the latent image bearing member 1 to the intermediate transfer member. This series of operations are performed on each of the four colors, cyan (C), magenta (M), yellow (Y), and black (K), to thereby form a full-color image.

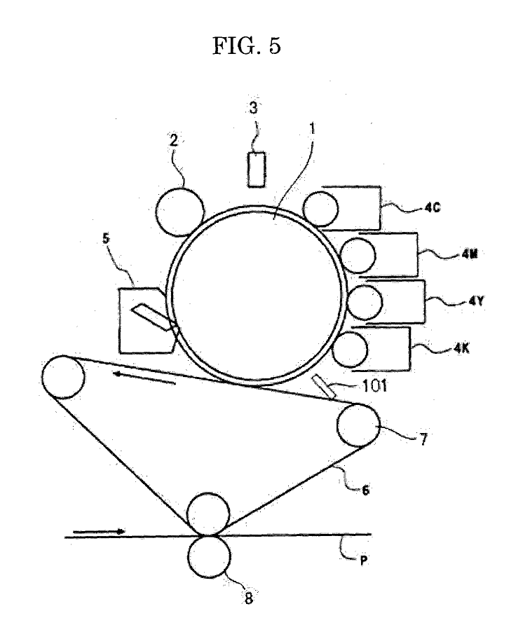

FIG. 5 is a schematic diagram illustrating one example of a full-color image forming apparatus equipped with a revolver developing unit.

This image forming apparatus successively deposits a plurality of colors of toners on one latent image bearing member 1 to perform developing, by switching the operation of the developing unit. The color toner image on the intermediate transfer member 6 is then transferred onto recording member P by means of the transfer roller 8, and the recording paper P onto which the toner image has been transferred is transported to a fixing unit, to thereby obtain a fixed image. Note that 101 denotes an intermediate transfer member cleaning blade in FIG. 5.

Meanwhile, in the image forming apparatus, a latent image bearing member, from which the toner image has been transferred to the recording paper by the intermediate transfer member 6, is further rotated, and the residual toner remained on the latent image bearing member 1 is removed by scraping with the blade of the cleaning unit 5, and then the latent image bearing member 1 is diselectrified by the diselectrification unit. The image forming apparatus enters into the next image formation operation after uniformly charging the latent image bearing member 1, which has been diselectrified by the diselectrification unit, by the charging unit 2. Note that, the cleaning unit 5 is not restricted to the embodiment where the blade is used to scrape the residual toner on the latent image bearing member 1, and may have an embodiment, for example, where a far brush is used to scrape the residual toner on the latent image bearing member 1.

The image forming method and image forming apparatus of the present invention can produce excellent images as they use the toner of the present invention as the developer.

### (Process Cartridge)

The process cartridge of the present invention contains at least a latent image bearing member configured to bear a latent electrostatic image, and a developing unit configured to develop the latent electrostatic image borne on the latent image bearing member using the toner of the present invention to form a visible image, and may further contain appropriately selected other units, such as a charging unit, a transferring unit, a cleaning unit, and a diselectrification unit, if necessary. In addition, the process cartridge of the present invention can be detachably mounted in a main body of an image forming apparatus.

The developing unit contains at least a developer container housing the toner of the present invention or a developer containing the toner of the present invention, and a developer bearing member configured to bear and transport the toner or developer housed in the developer container, and may further contain a layer thickness regulating member for regulating a thickness of a toner layer to be borne. The process cartridge can be detachably mounted in various electrophotographic image forming apparatuses, facsimiles, and printers, and is preferably detachably mounted in the image forming apparatus of the present invention.

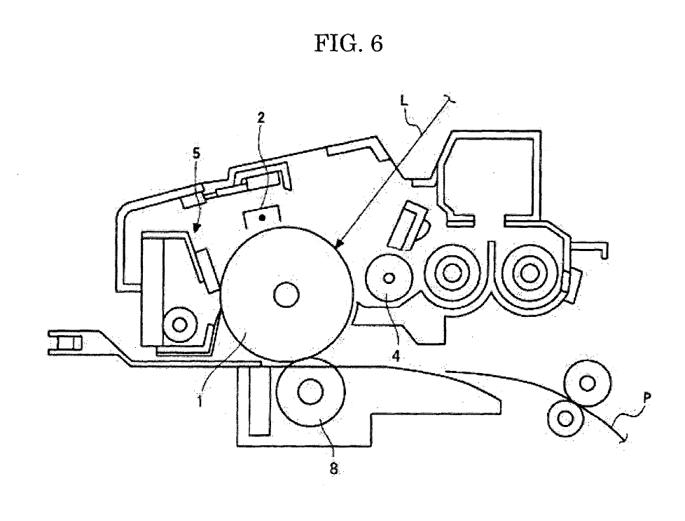

The process cartridge contains, for example as illustrated in FIG. 6, a built-in latent image bearing member 1, and contains a charging unit 2, a developing unit 4, a transfer roller 8, and a cleaning unit 5, and may further contain other units, if necessary. In FIG. 6, L represents light emitted from the exposing unit, and P represents recording paper. As for the latent image bearing member 1, the similar or same member to the one used in the image forming apparatus can be used. As for the charging unit 2, an appropriate charging member can be used.

An image forming process by the process cartridge of FIG. 6 is explained. The latent image bearing member 1 is charged by the charging unit 2, and exposed to light L by the exposing unit (not shown) while rotating, to thereby form a latent electrostatic image corresponding to an exposure image on the surface of the latent image bearing member 1. The latent electrostatic image is developed with the toner by the developing unit 4, and the resulting toner image is transferred to the recording paper P by means of the transfer roller 8, followed by output. Then, the surface of the latent image bearing member after the image transferring is cleaned by the cleaning unit 5, and then diselectrified by the diselectrification unit (not illustrated), followed by repeating the aforementioned operations.

### EXAMPLES

The present invention will be more specifically explained through Examples and Comparative Examples hereinafter, but these Examples shall not be construed as limiting the scope of the present invention in any way.

In the following descriptions, “part(s)” and “%” denotes “part(s) by mass” and “% by mass” respectively, unless otherwise stated.

First, analysis and evaluation methods of the toners obtained in Examples and Comparative Examples are explained.

In the following methods, the toner of the present invention was evaluated when the toner was used as a one component developer. The toner of the present invention however can be used for a two-component developer by subjecting to a suitable external additive treatment, and using a suitable carrier.

### <Measurement Method of Free Silicone Oil Amount>

The amount of the free silicone oil (free silicone oil amount) in the toner was measured by a quantitative method containing the following steps (1) to (3):

### (1) Extraction of Free Silicone Oil

A sample toner was soaked in chloroform, stirred, and left to stand.

To the solids obtained after removing a supernatant liquid by centrifugal separation, chloroform was added, and the resultant was stirred, and left to stand. This operation was repeated to remove free silicone oil from the sample.

### (2) Determination of Carbon Content

The carbon content of the sample from which the free silicone oil had been removed was measured by CHN elemental analyzer (CHN corder MT-5 (of Yanaco Co., Ltd.)).

### (3) Determination of Free Silicone Oil Amount

An amount of the free silicone oil was obtained by the following equation (1).

Free silicone oil amount=(C0−C1)/C×100×40/12(% by mass) Equation (1)

In the equation above, “C” is a carbon content (% by mass) of the silicone oil treating agent, “C0” is a carbon content (% by mass) of the sample before the extraction, “C1” is a carbon content (% by mass) of the sample after the extraction, and the coefficient “40/12” is the conversion factor for converting from the C (carbon) amount in the structure of the polydimethyl siloxane to the total amount

The structural formula of the polydimethyl siloxane is presented below:

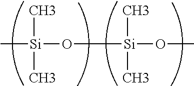

### (Particle Size Distribution of Toner)

The measurement method of the particle size distribution of the toner particles will be explained next.

As for the measuring device of the particle size distribution of the toner particles according to a counter method, Coulter Counter TA-II or Coulter Multisizer II (both manufactured by Beckman Coulter, Inc.) was used. The measuring method is as follow.

First, 0.1 mL to 5 mL of a surfactant (alkylbenzene sulfonate) was added as a dispersant to 100 mL to 150 mL of an electrolyte. Here, the electrolyte was an about 1% NaCl aqueous solution prepared using primary sodium chloride, and ISOTON-II (manufactured by Beckman Coulter, Inc.) was used as the electrolyte. Next, to the resulting mixture, 2 mg to 20 mg of a sample was added. The electrolyte in which the sample had been suspended was subjected to a dispersion treatment by means of an ultrasonic wave disperser for 1 minute to 3 minutes. By means of the measuring device with the aperture of 100 μm, the volume of the toner particles or the toner, and the number of the toner particles were measured from the resulting sample, and the volume distribution and the number distribution were calculated. The volume average particle diameter (Dv) and number average particle diameter (Dn) of the toner were determined from the obtained distributions.

As a channel, the following 13 channels were used: 2.00 μm or larger, but smaller than 2.52 μm; 2.52 μm or larger, but smaller than 3.17 μm; 3.17 μm or larger, but smaller than 4.00 μm; 4.00 μm or larger, but smaller than 5.04 μm; 5.04 μm or larger, but smaller than 6.35 μm; 6.35 μm or larger, but smaller than 8.00 μm; 8.00 μm or larger, but smaller than 10.08 μm; 10.08 μm or larger, but smaller than 12.70 μm; 12.70 μm or larger, but smaller than 16.00 μm; 16.00 μm or larger, but smaller than 20.20 μm; 20.20 μm or larger, but smaller than 25.40 μm; 25.40 μm or larger, but smaller than 32.00 μm: and 32.00 μm or larger, but smaller than 40.30 μm. As the target for the measurement, the particles having the diameters of 2.00 μm or larger but smaller than 40.30 μm were used.

### (Average Circularity of Toner)

As for the measuring method of the toner shape, an optical detecting zone method in which a suspension liquid containing particles was passed through an imaging part detecting zone provided on a plate, the particle image was optically detected by a CCD camera, and the image was then analyzed, was appropriate. The value obtained by dividing a length of a circumference of a circle having the same area to the projected area obtained in the aforementioned method with a length of a circumference of the actual particle is the average circularity of the toner.

The value is the value measured as the average circularity by means of a flow particle image analyzer FPIA-2000, manufactured by SYSMEX CORPORATION. The specific measuring method was as follow. To 100 mL to 150 mL of water contained in a container, from which impurity solids had been removed in advance, 0.1 mL to 0.5 mL of a surfactant as a dispersant, preferably alkyl benzene sulfonic acid salt, was added, and about 0.1 g to about 0.5 g of a sample was further added. The resulting suspension liquid in which the sample had been dispersed was subjected to a dispersion treatment by means of an ultrasonic wave disperser for 1 minute to 3 minutes, followed by measuring the shapes and particle size of the toner by means of the device with the dispersion liquid concentration of 3,000 particles/μL to 10,000 particles/μL.

### <Volume Average Particle Diameter of Resin Particles>

As for the measuring method of the volume average particle diameter of the resin particles, the volume average particle diameter of the resin particles was measured by a nanotrack particle size distribution measuring device UPA-EX150 (manufactured by Nikkiso Co., Ltd., dynamic light scattering/laser Doppler method). As for the specific measuring method, a dispersion in which the resin particles were dispersed was adjusted to have the concentration within the measuring concentration range, to thereby carry out the measurement. For the measurement, a dispersion medium of the dispersion liquid was subjected to back ground measurement in advance. In accordance with this measuring method, it was possible to measure the volume average particle diameter up to the range of several tends nanometers to several micrometers, which was the range of the volume average particle of the resin particles for use in the present invention.

### <Weight Average Molecular Weight>

The weight average molecular weight of the polyester resin or vinyl copolymer resin for use was measured by the general gel permeation chromatography (GPC) under the following conditions.

Device: HLC-8220GPC (manufactured by Tosoh Corporation)

Column: TSK gel Super HZM-M×3

Temperature: 40° C.

Solvent: tetrahydrofuran (THF)

Flow rate: 0.35 mL/min.

Sample: 0.01 mL of the sample having a concentration of 0.05% to 0.6% was supplied

From the molecular weight distribution of the toner resin measured under the conditions above, the weight average molecular weight Mw was calculated using a molecular weight calibration curve produced from a monodisperse polystyrene standard sample. As for the monodisperse polystyrene standard sample, samples of 5.8×100, 1.085×10,000, 5.95×10,000, 3.2×100,000, 2.56×1,000,000, 2.93×1,000, 2.85×10,000, 1.48×100,000, 8.417×100,000, and 7.5×1,000,000 (ten samples in total) were used.

### <Glass Transition Temperature and Endothermic Value>

The glass transition temperatures of the polyester resin and vinyl copolymer resin for use were measured by means of a differential scanning caloritometer (DSC-6220R, of Seiko Instruments Inc.). First, a sample was heated from the room temperature to 150° C. at the heating rate of 10° C./min, followed by being stood for 10 minutes at 150° C. Thereafter, the sample was cooled to the room temperature, followed by being stood for 10 minutes. Then, the sample was again heated to 150° C. at the heating rate of 10° C./min. The glass transition temperature could be determined from the base line at the glass transition temperature or lower, and the curve corresponding to the ½ height of the base line at the glass transition temperature or higher.

The endothermic values and melting points of the releasing agent and crystalline resin were measured in the same manner. The endothermic value was determined by calculating the peak area from the measured endothermic value. Generally, the releasing agent contained in the toner melts at the temperature lower than the fixing temperature of the toner. When the releasing agent melts, the heat of melting is generated and it appears as an endothermic peak. Depending on the releasing agent for use, the solid phase of the releasing agent generates the heat of transformation other than the heat of melting. In the examples, the sum of the aforementioned heat is determined as the endothermic value of the heat of melting.

### <BET Specific Surface Area>

The measurement of the BET specific surface area of the inorganic particles was performed by means of a surface area analyzer Autosorb-1 manufactured by Quantachrome Corporation in the following manner.

About 0.1 g of a measurement sample was weight and poured in a cell, and was subjected to deaeration at the temperature of 40° C. and the vacuum degree of 1.0×10⁻³ mmHg or lower for 12 hours or longer.

Thereafter, nitrogen gas was introduced to be adsorbed on the sample in the cooled state by liquid nitrogen, and the value was measured by a multi-point method.

### <Average Primary Particle Diameter of External Additive>

The average primary particle diameter of the inorganic particles as the external additive could be measured by a particle size distribution measuring device utilizing dynamic light scattering, for example, DLS-700 of Otsuka Electronics Co., Ltd., or Coulter N4 of Beckman Coulter, Inc.

It was however preferred that particle diameters be measured directly from a photograph obtained by a scanning electron microscope or transmission electron microscope, as it was difficult to dissociate secondary aggregation of particles after a silicone oil treatment.

In this case, at least one hundred inorganic particles were observed, and the average value of the major axis of the inorganic particles was determined.

### <Rebound Resilience of Cleaning Blade>

The rebound resilience of the cleaning blade was measured by a Lupke type rebound resilience tester (manufactured by Yasuda Seiki Seisakusho, Ltd.) at 23° C. in accordance with JIS K6255.

### <Contact Pressure of Cleaning Blade>

The pressing force of the cleaning blade was measured by providing a metal tube having the same diameter as the latent image bearing member, setting the metal tube so that the width of 5 mm thereof in the length direction was movable, and providing a load cell to the back side of the movable plane of the metal tube to measure the pressing force per length. The measured pressing force per length was determined as the contact pressure.

### <Cleaning Property (1) of Latent Image Bearing Member>

The predetermined print pattern having a B/W ratio of 6% was continuously printed on 1,000 sheets with monochrome mode by means of an image forming apparatus (IPSIO SP C220, manufactured by Ricoh Company Limited) under the N/N environment (23° C., 45% RH).

The latent image bearing member cleaning blade having the rebound resilience of 30% was mounted in the image forming apparatus with the contact pressure of 30 N/m, and the contact angle of 75° with respect to the latent image bearing member.

After completing the printing on the 1,000 sheets, the residual toner on the latent image bearing member was released by a sticky tape (T-Tape, manufactured by Kihara Corporation), and the tape was subjected to the measurement of L* by means of a spectrophotometer Xrite 939. The obtained value was evaluated based on the following criteria.

### [Evaluation Criteria]

A: 90 or higher

B: 85 or higher but lower than 90

C: 80 or higher but lower than 85

D: lower than 80

### <Cleaning Property of Latent Image Bearing Member (2)>

The predetermined print pattern having a B/W ratio of 6% was continuously printed on 1,000 sheets with monochrome mode by means of an image forming apparatus (IPSIO SP C220, manufactured by Ricoh Company Limited) under the L/L environment (10° C., 15% RH).

The latent image bearing member cleaning blade having the rebound resilience of 10% was mounted in the image forming apparatus with the contact pressure of 20 N/m, and the contact angle of 82° with respect to the latent image bearing member. Note that, this condition is a condition where the performance of stopping the external additive and toner can be most degraded as the latent image bearing member cleaning blade has the low rebound resilience, and the contact pressure is low and the contact angle is large and the experiment is performed in the L/L environment.

After completing the printing on the 1,000 sheets, the residual toner on the latent image bearing member was released by a sticky tape (T-Tape, manufactured by Kihara Corporation), and the tape was subjected to the measurement of L* by means of a spectrophotometer Xrite 939. The obtained value was evaluated based on the following criteria.

### [Evaluation Criteria]

A: 90 or higher

B: 85 or higher but lower than 90

C: 80 or higher but lower than 85

D: lower than 80

### <Cleaning Property (3) of Latent Image Bearing Member>

The predetermined print pattern having a B/W ratio of 6% was continuously printed on 1,000 sheets with monochrome mode by means of an image forming apparatus (IPSIO SP C220, manufactured by Ricoh Company Limited) under the H/H environment (27° C., 80% RH).

The latent image bearing member cleaning blade having the rebound resilience of 35% was mounted in the image forming apparatus with the contact pressure of 50 N/m, and the contact angle of 70° with respect to the latent image bearing member. Note that, this condition is a condition where catching of the cleaning blade by the latent image bearing member is most likely caused, as the latent image bearing member cleaning blade has the high rebound resilience, and the contact pressure is high and the contact angle is small and the experiment is performed in the H/H environment.

During the printing of 1,000 sheets under the aforementioned condition, the number of the printed sheets when the latent image bearing member cleaning blade was first caught was counted, and the obtained number was evaluated based on the following criteria. Note that, the larger the number of the sheets printed untill the catching of the latent image bearing member cleaning blade occur is, more excellent the cleaning property is.

### [Evaluation Criteria]

A: 1,000 sheets or more

B: 900 sheets or more but less than 1,000 sheets

C: 800 sheets or more but less than 900 sheets

D: less than 800 sheets

### <Abrasion Amount of Latent Image Bearing Member>

A film thickness of the latent image bearing member was measured before and after the evaluation of the cleaning property (1), and from the obtained values, the film abrasion about determined. The result was evaluated based on the following criteria. Note that, the film thickness of the latent image bearing member was measured by measuring the film thickness at arbitrarily selected 80 measurement points by means of an eddy current film thickness analyzer (manufactured by Fischer Instruments K.K.), and taking the average value of the obtained values as the film thickness.

### [Evaluation Criteria]

A: 0.3 μm or less

B: more than 0.3 μm, but 0.4 μm or lower

C: more than 0.4 μm, but 0.6 μm or lower

D: more than 0.6 μm

### <Contamination of Regulation Blade>

A change in the charging amount of the toner was measured before and after the cleaning evaluation (1) of the latent image bearing member, and the degree of the contamination of the regulation blade was evaluated based on the following criteria. Note that, the measurement of the charging amount was performed on the toner present on the developing roller, by means of a draw-off portable Q/M analyzer manufactured by TREK Japan K.K., and the charge amount was obtained as the 10-point average.

### [Evaluation Criteria]

A: difference in charging amount being 5 μC/g or less

B: difference in charging amount being more than 5 μC/g but 10 μC/g or less

C: difference in charging amount being more than 10 μC/g but 15 μC/g or less

D: difference in charging amount being more than 15 μC/g

### <Cleaning Property (1) of Intermediate Transfer Member>

The predetermined print pattern having a B/W ratio of 6% was continuously printed on 1,000 sheets with monochrome mode by means of an image forming apparatus (IPSIO SP C220, manufactured by Ricoh Company Limited) under the L/L environment (10° C., 15% RH).

The intermediate transfer member cleaning blade having the rebound resilience of 35% was mounted in the image forming apparatus with the contact pressure of 20 N/m, and the contact angle of 82° with respect to the intermediate transfer member. Note that, this condition is a condition where the performance of stopping the external additive and toner can be most degraded as the intermediate transfer member cleaning blade has the low rebound resilience, and the contact pressure is low and the contact angle is large and the experiment is performed in the L/L environment.

After completing the printing on the 1,000 sheets, the residual toner on the intermediate transfer member was released by a sticky tape (T-Tape, manufactured by Kihara Corporation), and the tape was subjected to the measurement of L* by means of a spectrophotometer Xrite 939. The obtained value was evaluated based on the following criteria.

### [Evaluation Criteria]

A: 90 or higher

B: 85 or higher but lower than 90

C: 80 or higher but lower than 85

D: lower than 80

### <Cleaning Property (2) of Intermediate Transfer Member>

The predetermined print pattern having a B/W ratio of 6% was continuously printed on 1,000 sheets with monochrome mode by means of an image forming apparatus (IPSIO SP C220, manufactured by Ricoh Company Limited) under the H/H environment (27° C., 80% RH).

The intermediate transfer member cleaning blade having the rebound resilience of 55% was mounted in the image forming apparatus with the contact pressure of 50 N/m, and the contact angle of 70° with respect to the intermediate transfer member. Note that, this condition is a condition where breakage and catching of the intermediate transfer member cleaning blade by the intermediate transfer member is most likely caused, as the cleaning blade has the high rebound resilience, and the contact pressure is high and the contact angle is small and the experiment is performed in the H/H environment.

During the printing of 1,000 sheets under the aforementioned condition, the number of the printed sheets when the intermediate transfer member cleaning blade was first caught was counted, and the obtained number was evaluated based on the following criteria. Note that, the larger the number of the sheets printed untill the catching of the intermediate transfer member cleaning blade occur is, more excellent the cleaning property is.

### [Evaluation Criteria]

A: 1,000 sheets or more

B: 900 sheets or more but less than 1,000 sheets

C: 800 sheets or more but less than 900 sheets

D: less than 800 sheets

### <Abrasion Amount of Intermediate Transfer Member>

The number of the longitudinal lines formed in the intermediate transfer member was measured before and after the evaluation of the cleaning property (1) of the intermediate transfer member to measure the abrasion amount, and the results were evaluated based on the following criteria.

### [Evaluation Criteria]

A: 5 lines or less

B: more than 5 lines, but 10 lines or less

C: more than 10 lines, but 20 lines or less

D: more than 20 lines

### <Contamination of Regulation Blade (Contamination of Developing Member)>

A change in the charging amount of the toner was measured before and after the cleaning evaluation (1) of the intermediate transfer member, and the degree of the contamination of the regulation blade was evaluated based on the following criteria. Note that, the measurement of the charging amount was performed on the toner present on the developing roller, by means of a draw-off portable Q/M analyzer manufactured by TREK Japan K.K., and the charge amount was obtained as the 10-point average.

### [Evaluation Criteria]

A: difference in charging amount being 5 μC/g or less

B: difference in charging amount being more than 5 μC/g but 10 μC/g or less

C: difference in charging amount being more than 10 μC/g but 15 μC/g or less

D: difference in charging amount being more than 15 μC/g

Preparation methods of raw materials of a toner used in Examples will be explained next.

### <Method of External Additive Treatment>

### (Silica 1)

A predetermined amount of 300-cs polydimethyl siloxane (manufactured by Shin-Etsu Chemical Co., Ltd.) serving as silicone oil was dissolved in 30 parts of hexane, and to this, 100 parts of external additive to be treated (OX50 manufactured by Nippon Aerosil Co., Ltd., untreated silica having the average particle diameter of 35 nm) was added, and dispersed by applying ultrasonic waves with stirring.

The silicone oil was introduced under the purged atmosphere by nitrogen with stirring to give the amount of the silicone oil presented in Table 1A-1, and in the state where the stirring was continued, the external additive was treated with the reaction temperature and duration presented in Table 1A-1 to thereby obtain Silica 1.

Silicas 2 to 9, Titania 1, and Alumina 1 were obtained in the same manner as in Silica 1, provided the changes presented in Tables 1A-1, 1A-2, 1B-1, and 1B-2.

Table 1A-2 presents the carbon content of the silicone oil-treated silica, free carbon ratio, and amount of the remained carbon. Table 1B-2 present the values obtained by converting the values presented in Table 1A-2 into the silicone oil (PDMS: polydimethyl siloxane) content in the silicone oil-treated silica, free silicone oil rate, and amount of the remaining silicone oil.

TABLE 1A-1

| | Production conditions | | | | | |
|---|---|---|---|---|---|---|
| | | Treat- | | BET | | External |
| | | ment | Treat- | specific | Silicone | additive |
| | PDMS | temper- | ment | surface | oil | particle |
| | amount | ature | duration | area | amount | diameter |
| | in parts | ° C. | min. | m²/g | mg/m² | nm |
| Silica 1 | 10 | 150 | 15 | 50 | 2 | 35 |
| Silica 2 | 20 | 200 | 15 | 50 | 4 | 35 |
| Silica 3 | 20 | 200 | 15 | 50 | 4 | 35 |
| Silica 4 | 20 | 150 | 15 | 50 | 4 | 35 |
| Silica 4 | 20 | 150 | 15 | 50 | 4 | 35 |
| Silica 1 | 10 | 150 | 15 | 50 | 2 | 35 |
| Titania 1 | 20 | 200 | 15 | 30 | 6.7 | 50 |
| Alumina 1 | 20 | 200 | 15 | 40 | 5 | 40 |
| Silica 7 | 10 | 150 | 15 | 22 | 4.5 | 80 |
| Silica 8 | 10 | 200 | 15 | 10 | 10 | 140 |
| Silica 9 | 20 | 150 | 15 | 90 | 2.2 | 25 |
| Silica 3 | 20 | 200 | 15 | 50 | 4 | 35 |
| Silica 5 | 8 | 200 | 15 | 50 | 1.6 | 35 |
| Silica 6 | 10 | 250 | 15 | 50 | 2 | 35 |
| Silica 4 | 20 | 150 | 15 | 50 | 4 | 35 |
| Titania 1 | 20 | 200 | 15 | 30 | 6.7 | 50 |
| Alumina 1 | 20 | 200 | 15 | 40 | 5 | 40 |

TABLE 1A-2

| | | | Free | Remaining | Free | Remaining |
|---|---|---|---|---|---|---|
| | Amount of | | carbon | carbon | carbon | carbon |
| | carbon derived | | rate | rate | amount | amount |
| | from silicone oil | | derived | derived | derived | derived |
| | in external | | from | from | from | from |
| | additive | | silicone | silicone oil | silicone | silicone oil |
| | Before | After | oil in | in | oil in | in |
| | extrac- | extrac- | external | external | external | external |
| | tion | tion | additive | additive | additive | additive |
| | wt % | wt % | % | % | wt % | wt % |
| Silica 1 | 3.1 | 0.6 | 81 | 19 | 2.5 | 0.6 |
| Silica 2 | 5.8 | 2.5 | 57 | 43 | 3.3 | 2.5 |
| Silica 3 | 6.2 | 2.1 | 66 | 34 | 4.1 | 2.1 |
| Silica 4 | 5.9 | 0.8 | 86 | 14 | 5.1 | 0.8 |
| Silica 4 | 5.9 | 0.8 | 86 | 14 | 5.1 | 0.8 |
| Silica 1 | 3.1 | 0.6 | 81 | 19 | 2.5 | 0.6 |
| Titania 1 | 5.7 | 2.4 | 58 | 42 | 3.3 | 2.4 |
| Alumina 1 | 5.5 | 2.3 | 58 | 42 | 3.2 | 2.3 |
| Silica 7 | 3.5 | 1 | 71 | 29 | 2.5 | 1 |
| Silica 8 | 8.2 | 3 | 63 | 37 | 5.2 | 3 |
| Silica 9 | 5.2 | 1.5 | 71 | 29 | 3.7 | 1.5 |
| Silica 3 | 6.2 | 2.1 | 66 | 34 | 4.1 | 2.1 |
| Silica 5 | 2.8 | 1.7 | 39 | 61 | 1.1 | 1.7 |
| Silica 6 | 3.5 | 1.9 | 46 | 54 | 1.6 | 1.9 |
| Silica 4 | 5.9 | 0.8 | 86 | 14 | 5.1 | 0.8 |
| Titania 1 | 5.7 | 2.4 | 58 | 42 | 3.3 | 2.4 |
| Alumina 1 | 5.5 | 2.3 | 58 | 42 | 3.2 | 2.3 |

TABLE 1B-1

| | Production conditions | | | BET | | |
|---|---|---|---|---|---|---|
| | PDMS | Treatment | Treatment | specific | Silicone oil | External additive |
| | amount | temperature | duration | surface area | amount | particle diameter |
| | in parts | ° C. | min. | m²/g | mg/m² | nm |
| Silica 1 | 10 | 150 | 15 | 50 | 2 | 35 |
| Silica 2 | 20 | 200 | 15 | 50 | 4 | 35 |
| Silica 3 | 20 | 200 | 15 | 50 | 4 | 35 |
| Silica 4 | 20 | 150 | 15 | 50 | 4 | 35 |
| Silica 4 | 20 | 150 | 15 | 50 | 4 | 35 |
| Silica 1 | 10 | 150 | 15 | 50 | 2 | 35 |
| Titania 1 | 20 | 200 | 15 | 30 | 6.7 | 50 |
| Alumina 1 | 20 | 200 | 15 | 40 | 5 | 40 |
| Silica 7 | 10 | 150 | 15 | 22 | 4.5 | 80 |
| Silica 8 | 10 | 200 | 15 | 10 | 10 | 140 |
| Silica 9 | 20 | 150 | 15 | 90 | 2.2 | 25 |
| Silica 3 | 20 | 200 | 15 | 50 | 4 | 35 |
| Silica 5 | 8 | 200 | 15 | 50 | 1.6 | 35 |
| Silica 6 | 10 | 250 | 15 | 50 | 2 | 35 |
| Silica 4 | 20 | 150 | 15 | 50 | 4 | 35 |
| Titania 1 | 20 | 200 | 15 | 30 | 6.7 | 50 |
| Alumina 1 | 20 | 200 | 15 | 40 | 5 | 40 |

TABLE 1B-2

| | Amount of | | | | | |
|---|---|---|---|---|---|---|
| | PDMS in | | | | Free | |
| | external | | Free | Remaining | PDMS | Remaining |
| | additive | | PDMS | PDMS | amount | PDMS |
| | Before | After | rate in | rate in | in | amount in |
| | extrac- | extrac- | external | external | external | external |
| | tion | tion | additive | additive | additive | additive |
| | wt % | wt % | % | % | wt % | wt % |
| Silica 1 | 10.3 | 2.0 | 81 | 19 | 8.3 | 2.0 |
| Silica 2 | 19.3 | 8.3 | 57 | 43 | 11.0 | 8.3 |
| Silica 3 | 20.7 | 7.0 | 66 | 34 | 13.7 | 7.0 |
| Silica 4 | 19.7 | 2.7 | 86 | 14 | 17.0 | 2.7 |
| Silica 4 | 19.7 | 2.7 | 86 | 14 | 17.0 | 2.7 |
| Silica 1 | 10.3 | 2.0 | 81 | 19 | 8.3 | 2.0 |
| Titania 1 | 19.0 | 8.0 | 58 | 42 | 11.0 | 8.0 |
| Alumina 1 | 18.3 | 7.7 | 58 | 42 | 10.7 | 7.7 |
| Silica 7 | 11.7 | 3.3 | 71 | 29 | 8.3 | 3.3 |
| Silica 8 | 27.3 | 10.0 | 63 | 37 | 17.3 | 10.0 |
| Silica 9 | 17.3 | 5.0 | 71 | 29 | 12.3 | 5.0 |
| Silica 3 | 20.7 | 7.0 | 66 | 34 | 13.7 | 7.0 |
| Silica 5 | 9.3 | 5.7 | 39 | 61 | 3.7 | 5.7 |
| Silica 6 | 11.7 | 6.3 | 46 | 54 | 5.3 | 6.3 |
| Silica 4 | 19.7 | 2.7 | 86 | 14 | 17.0 | 2.7 |
| Titania 1 | 19.0 | 8.0 | 58 | 42 | 11.0 | 8.0 |
| Alumina 1 | 18.3 | 7.7 | 58 | 42 | 10.7 | 7.7 |

### <Synthesis of Non-Crystalline Polyester>

### (Polyester 1)

A reaction vessel equipped with a cooling pipe, a stirrer, and a nitrogen introducing pipe was charged with 2,765 parts of bisphenol A ethylene oxide 2 mol adduct, 480 parts of bisphenol A propylene oxide 2 mol adduct, 1,100 parts of terephthalic acid, 225 parts of adipic acid, and 10 parts of dibutyl tin oxide, and the resulting mixture was allowed to react for 8 hours at 230° C. under normal pressure, and then allowed to react for 5 hours under the reduced pressure of 10 mmHg to 15 mmHg. Thereafter, 130 parts of trimellitic anhydride was added into the reaction vessel, and the resulting mixture was allowed to react for 2 hours at 180° C. under the normal pressure to thereby obtain Polyester 1. Polyester 1 had the number average molecular weight of 2,200, the weight average molecular weight of 5,600, the glass transition temperature Tg of 43° C., and the acid value of 24 mgKOH/g.

### (Polyester 2)

A reaction vessel equipped with a cooling pipe, a stirrer, and a nitrogen introducing pipe was charged with 264 parts of bisphenol A ethylene oxide 2 mol adduct, 523 parts of bisphenol A propylene oxide 2 mol adduct, 123 parts of terephthalic acid, 173 parts of adipic acid, and 1 part of dibutyl tin oxide, and the resulting mixture was allowed to react for 8 hours at 230° C. under the normal pressure, and then allowed to react for 8 hours under the reduced pressure of 10 mmHg to 15 mmHg. Thereafter, 26 parts of trimellitic anhydride was added into the reaction vessel, and the resulting mixture was allowed to react for 2 hours at 180° C. under the normal pressure to thereby obtain Polyester 2. Polyester 2 had the number average molecular weight of 4,000, the weight average molecular weight of 17,000, the glass transition temperature Tg of 65° C., and the acid value of 12 mgKOH/g.

### <Synthesis of Crystalline Polyester>

### (Polyester 3)

A reaction vessel equipped with a cooling pipe, a stirrer, and a nitrogen introducing pipe was charged with 500 parts of 1,6-hexanediol, 500 parts of succinic acid, and 2.5 parts of dibutyl tin oxide, and the resulting mixture was allowed to react for 8 hours at 200° C. under the normal pressure, and then was allowed to react for 1 hour under the reduced pressure of 10 mmHg to 15 mmHg to thereby obtain Polyester 3. Polyester 3 exhibited an endothermic peak at 65° C. in the DSC measurement.

### <Synthesis of Prepolymer>

A reaction vessel equipped with a cooling pipe, a stirrer, and a nitrogen introducing pipe was charged with 366 parts of 1,2-propylene glycol, 566 parts of terephthalic acid, 44 parts of trimellitic anhydride, and 6 parts of titanium tetrabutoxide, and the resulting mixture was allowed to react for 8 hours at 230° C. under the normal pressure, and then was allowed to react for 5 hours under the reduced pressure of 10 mmHg to 15 mmHg to thereby obtain Intermediate Polyester 1. Intermediate Polyester 1 had the number average molecular weight of 3,200, the weight average molecular weight of 12,000, and the glass transition temperature Tg of 55° C.

Next, a reaction vessel equipped with a cooling pipe, a stirrer, and a nitrogen introducing pipe was charged with 420 parts of Intermediate Polyester 1, 80 parts of isophorone diisocyanate, and 500 parts of ethyl acetate, and the resulting mixture was allowed to react for 5 hours at 100° C. to thereby obtain Prepolymer. Prepolymer had the free isocyanate (% by mass) of 1.34%.

### <Preparation of Dispersion Liquid of Resin Particles for Shell Layer>

### (Vinyl Copolymer Resin Particles V-1)

A reaction vessel equipped with a cooling pipe, a stirrer, and a nitrogen introducing pipe was charged with 1.6 parts of sodium dodecyl sulfate, and 492 parts of ion-exchanged water, and the resulting mixture was heated to 80° C. Thereafter, a solution in which 2.5 parts of potassium persulfate was dissolved in 100 parts of ion-exchanged water was added to the mixture. Fifteen minutes later, to this mixture, a mixed liquid of 160 parts of styrene monomer, 40 parts of butyl acrylate monomer, and 3.5 parts of n-octyl mercaptan was added dropwise over the period of 90 minutes, and the temperature of the resulting mixture was maintained at 80° C. for another 60 minutes. Thereafter, the resultant was cooled to thereby obtain a dispersion liquid of Vinyl Copolymer Resin Particles V-1. The solid content of this dispersion liquid was measured, and it was 25%. Moreover, the particles had the volume average particle diameter of 130 nm. A small amount of the dispersion liquid was taken in a dish, and the dispersion medium was evaporated to obtain and measure the solids. The resulting solids had the number average molecular weight of 11,000, the weight average molecular weight of 18,000, and the glass transition temperature Tg of 83° C.

### <Synthesis of Master Batch>

Forty parts of carbon black (REGAL 400R of Cabot Corporation), 60 parts of polyester resin (RS-801 of Sanyo Chemical Industries, Ltd., acid value: 10, Mw: 20,000, Tg: 64° C.) serving as a binder resin, and 30 parts of water were mixed by means of HENSCHEL MIXER, to thereby obtain a mixture in which water was penetrated into the pigment aggregates. This mixture was kneaded for 45 minutes by means of a two-roll mill in which the temperature of the roll table surface was set at 130° C., and the resulting kneaded product was pulverized into a diameter of 1 mm by a pulverizer, to thereby obtain Master Batch 1.

### Example 1

### Preparation of Oil Phase

A container equipped with a stirring bar and a thermometer was charged with 4 parts of Polyester 1, 20 parts of Polyester 3, 8 parts of paraffin wax (melting point: 72° C.), and 96 parts of ethyl acetate, and the resulting mixture was heated to 80° C. with stirring, and the temperature was kept at 80° C. for 5 hours, followed by cooling to 30° C. over the period of 1 hour. To the resultant, 35 parts of Master Batch 1 was added, and the mixture was mixed for 1 hour. The resulting mixture was moved into another container, and then dispersed by a bead mill (ULTRA VISCOMILL, manufactured by AIMEX Co., Ltd.) under the following conditions: a liquid feed rate of 1 kg/hr, disc circumferential velocity of 6 m/s, 0.5 mm-zirconium beads packed to 80% by volume, and 3 passes, to thereby obtain Raw Material Solution 1. Next, to 81.3 parts of Raw Material Solution 1, 74.1 parts of a 70% ethyl acetate solution of Polyester 1, 21.6 parts of Polyester 2, and 21.5 parts of ethyl acetate were added, and the mixture was stirred by means of a three-one motor for 2 hours to thereby obtain Oil Phase 1. Ethyl acetate was added to Oil Phase 1 to adjust the solid concentration (measured at 130° C., for 30 minutes) of Oil Phase 1 to be 49%.

### Preparation of Aqueous Phase

Ion-exchanged water (472 parts), 81 parts of a 50% sodium dodecyl diphenyl ether disulfonate aqueous solution (ELEMINOL MON-7, manufactured by Sanyo Chemical Industries Ltd.), 67 parts of a 1% carboxy methyl cellulose aqueous solution serving as a thickener, and 54 parts of ethyl acetated were mixed and stirred to thereby obtain an opaque white liquid, which was used as Aqueous Phase 1.

### Emulsifying Step

After stirring Oil Phase 1 by means of TK Homomixer (manufactured by Tokushu Kika Kogyo Co., Ltd.) at 5,000 rpm for 1 minute, 321 parts of Aqueous Phase 1 was added relative to the total amount of Oil Phase 1, and the resulting mixture was mixed and stirred by means of TK Homomixer for 20 minutes while adjusting the rotational number thereof in the range of 8,000 rpm to 13,000 rpm, to thereby obtain Core Particle Slurry 1.

### Shell Formation Step

### Step for Depositing Resin Particles to Core Particles

While stirring Core Particle Slurry 1 by means of a three-one motor at 200 rpm, 21.4 parts of Vinyl Copolymer Resin Particles V-1 was added to Core Particle Slurry 1 dropwise over the period of 5 minutes, and the resulting mixture was kept stirred for another 30 minutes. Thereafter, a small amount of the slurry was sampled, and the collected slurry was diluted 10-fold. The resultant was subjected to centrifugal separation by means of a centrifugal separator. As a result, the toner base particles were settled on the bottom of the test tube, and the supernatant liquid was substantially clear. In the manner mentioned above, Slurry after Forming Shell 1 was obtained.

### Removal of Solvent

A container equipped with a stirrer and a thermometer was charged with Slurry after Forming Shell 1, and the solvent was removed from Slurry after Forming Shell 1 at 30° C. for 8 hours, to thereby Dispersion Slurry 1.

### Washing and Drying

Dispersion Slurry 1 (100 parts) was filtrated under reduced pressure and then washed and dried in the following manner.

(1): Ion-exchanged water (100 parts) was added to the filtration cake, and the mixture was mixed with TK Homomixer (at 12,000 rpm for 10 minutes), followed by filtration.

(2): Ion-exchanged water (100 parts) was added to the filtration cake obtained in (1), and the mixture was mixed by applying ultrasonic wave vibrations by means of TK Homomixer (at 12,000 rpm for 30 minutes) followed by filtration under reduced pressure. This operation was repeated until the electric conductivity of the reslurry became 10 μS/cm or lower.

(3): 10% hydrochloric acid was added to the reslurry obtained in (2) to adjust the pH to 4, and the resultant was stirred by means of a three-one motor for 30 minutes, followed by subjected to filtration.

(4): Ion-exchanged water (100 parts) was added to the filtration cake obtained in (3), and the mixture was mixed by means of TK Homomixer (at 12,000 rpm for 10 minutes), followed by subjected to filtration. This operation was repeated until the electric conductivity of the reslurry became 10 μS/cm or lower, to thereby obtain Filtration Cake 1. The remaining of Dispersion Slurry 1 was washed in the same manner, and the resultant was added and mixed as Filtration Cake 1.

Filtration Cake 1 was dried with an air-circulating drier for 48 hours at 45° C., and was then passed through a sieve with a mesh size of 75 μm, to thereby obtain Toner Base Particles 1.

To the obtained base toner particles (100 parts), 3 parts of the silicone oil-treated hydrophobic silica presented in Table 2A-1, and 1 part of hydrophobic silica having the average primary particle diameter of 10 nm were added and mixed by means of HENSCHEL MIXER to thereby obtain a toner of Example 1.

The volume average particle diameter Dv, number average particle diameter Dn, ratio (Dv/Dn), and average circularity of the obtained toner were measured by the method explained above, and it was found that the toner had the average circularity of 0.99, the volume average particle diameter (Dv) of 6.1 μm, the number average particle diameter (Dn) of 5.3 and Dv/Dn of 1.15.

### Examples 2 to 11 and Comparative Examples 1 to 6

Toners of Examples 2 to 11 and Comparative Examples 1 to 6 were obtained in the same manner as in Example 1, provided that the external additives presented in Tables 2A-1 and 2B-1 were respectively used. Note that, the average circularity of each toner was changed by adjusting the rotational number of TK Homomixer during the production of the toner. The average circularity of each toner is presented in Tables 2A-2 and 2B-2.

The obtained toners of Examples 1 to 11 and Comparative Examples 1 to 6 were evaluated in terms of the aforementioned cleaning properties (1) to (3), film abrasion amount of the latent image bearing member, and contamination of the regulation blade. The results are presented in Tables 2A-2 and 2B-2.

Table 2A-1 is presented based on the carbon content, and Table 2B-1 is presented based on the PDMS content.

It was found from the evaluation results presented in tables that the toner of the present invention excelled in the cleaning properties and the film abrasion amount compared to the toners of Comparative Examples.

TABLE 2A-1

| | | | | In silicone oil- | | | |
|---|---|---|---|---|---|---|---|
| | | | | treated external additive | | | |
| | | | | | Total | Total free | Total |
| | | Amount of | | Total free | remaining | carbon | remaining |
| | | silicone oil | Amount of | carbon | carbon | amount | carbon amount |
| | | treated external | HMDS treated | amount | amount | derived | derived from |
| | | additive | external additive | derived from | derived from | from silicone | silicone |
| | External | in toner | in toner | silicone oil | silicone oil | oil in toner | oil in toner |
| | additive | part | part | part | part | wt % | wt % |
| Ex. 1 | Silica 1 | 3 | 1 | 0.075 | 0.018 | 0.072 | 0.017 |
| Ex. 2 | Silica 2 | 3 | 1 | 0.099 | 0.075 | 0.095 | 0.072 |
| Ex. 3 | Silica 3 | 3 | 1 | 0.123 | 0.063 | 0.118 | 0.061 |
| Ex. 4 | Silica 4 | 3 | 1 | 0.153 | 0.024 | 0.147 | 0.023 |
| Ex. 5 | Silica 4 | 2 | 1 | 0.102 | 0.016 | 0.099 | 0.016 |
| Ex. 6 | Silica 1 | 4 | 1 | 0.100 | 0.024 | 0.095 | 0.023 |
| Ex. 7 | Titania 1 | 3 | 1 | 0.099 | 0.072 | 0.095 | 0.069 |
| Ex. 8 | Alumina 1 | 3 | 1 | 0.096 | 0.069 | 0.092 | 0.066 |
| Ex. 9 | Silica 7 | 3 | 1 | 0.063 | 0.025 | 0.060 | 0.024 |
| Ex. 10 | Silica 8 | 2 | 1 | 0.104 | 0.060 | 0.101 | 0.058 |
| Ex. 11 | Silica 9 | 3 | 1 | 0.111 | 0.045 | 0.107 | 0.043 |
| Comp. | Silica 3 | 4 | 1 | 0.164 | 0.084 | 0.156 | 0.080 |
| Ex. 1 | | | | | | | |
| Comp. | Silica 5 | 3 | 1 | 0.033 | 0.051 | 0.032 | 0.049 |
| Ex. 2 | | | | | | | |
| Comp. | Silica 6 | 3 | 1 | 0.048 | 0.057 | 0.046 | 0.055 |
| Ex. 3 | | | | | | | |
| Comp. | Silica 4 | 1 | 1 | 0.051 | 0.008 | 0.050 | 0.008 |
| Ex. 4 | | | | | | | |
| Comp. | Titania 1 | 1 | 1 | 0.033 | 0.024 | 0.032 | 0.024 |
| Ex. 5 | | | | | | | |
| Comp. | Alumina 1 | 1 | 1 | 0.032 | 0.023 | 0.031 | 0.023 |
| Ex. 6 | | | | | | | |

TABLE 2A-2

| | Average | Cleaning | Cleaning | Cleaning | Film abrasion | | Regulation |
|---|---|---|---|---|---|---|---|
| | circularity | property | property | property | amount | | blade |
| | of toner | (1) | (2) | (3) | μm/1,000 | | contamination |
| Ex. 1 | 0.99 | B | C | C | 0.5 | C | A |
| Ex. 2 | 0.96 | A | B | B | 0.4 | B | B |
| Ex. 3 | 0.97 | A | A | A | 0.3 | A | C |
| Ex. 4 | 0.98 | A | A | A | 0.2 | A | C |
| Ex. 5 | 0.98 | A | B | B | 0.4 | B | B |
| Ex. 6 | 0.99 | A | B | B | 0.4 | B | B |
| Ex. 7 | 0.96 | A | B | B | 0.5 | C | A |
| Ex. 8 | 0.98 | A | B | B | 0.4 | A | B |
| Ex. 9 | 0.99 | B | C | C | 0.6 | C | A |
| Ex. 10 | 0.96 | A | B | B | 0.4 | B | B |
| Ex. 11 | 0.99 | B | C | C | 0.6 | C | C |
| Comp. | 0.99 | A | A | A | 0.3 | A | D |
| Ex. 1 | | | | | | | |
| Comp. | 0.96 | D | D | D | 1.0 | D | A |
| Ex. 2 | | | | | | | |
| Comp. | 0.95 | C | D | C | 0.8 | D | A |
| Ex. 3 | | | | | | | |
| Comp. | 0.95 | C | D | C | 0.8 | D | A |
| Ex. 4 | | | | | | | |
| Comp. | 0.97 | D | D | D | 1.0 | D | A |
| Ex. 5 | | | | | | | |
| Comp. | 0.98 | D | D | D | 1.0 | D | A |
| Ex. 6 | | | | | | | |

TABLE 2B-1

| | | Amount of | | In silicone | | | |
|---|---|---|---|---|---|---|---|
| | | silicone | Amount | oil-treated external | | | |
| | | oil | of HMDS | additive | | Total free | Total |
| | | treated | treated | Total | Total | PDMS | remaining |
| | | external | external | free | remaining | amount | PDMS |
| | | additive | additive | PDMS | PDMS | in | amount in |
| | External | in toner | in toner | amount | amount | toner | toner |
| | additive | part | part | part | part | wt % | wt % |
| Ex. 1 | Silica 1 | 3 | 1 | 0.250 | 0.060 | 0.240 | 0.058 |
| Ex. 2 | Silica 2 | 3 | 1 | 0.330 | 0.250 | 0.317 | 0.240 |
| Ex. 3 | Silica 3 | 3 | 1 | 0.410 | 0.210 | 0.394 | 0.202 |
| Ex. 4 | Silica 4 | 3 | 1 | 0.510 | 0.080 | 0.490 | 0.077 |
| Ex. 5 | Silica 4 | 2 | 1 | 0.340 | 0.053 | 0.330 | 0.052 |
| Ex. 6 | Silica 1 | 4 | 1 | 0.333 | 0.080 | 0.317 | 0.076 |
| Ex. 7 | Titania 1 | 3 | 1 | 0.330 | 0.240 | 0.317 | 0.231 |
| Ex. 8 | Alumina 1 | 3 | 1 | 0.320 | 0.230 | 0.308 | 0.221 |
| Ex. 9 | Silica 7 | 3 | 1 | 0.208 | 0.083 | 0.201 | 0.081 |
| Ex. 10 | Silica 8 | 2 | 1 | 0.347 | 0.200 | 0.337 | 0.194 |
| Ex. 11 | Silica 9 | 3 | 1 | 0.370 | 0.150 | 0.356 | 0.144 |
| Comp. | Silica 3 | 4 | 1 | 0.547 | 0.280 | 0.521 | 0.267 |
| Ex. 1 | | | | | | | |
| Comp. | Silica 5 | 3 | 1 | 0.110 | 0.170 | 0.106 | 0.163 |
| Ex. 2 | | | | | | | |
| Comp. | Silica 6 | 3 | 1 | 0.160 | 0.190 | 0.154 | 0.183 |
| Ex. 3 | | | | | | | |
| Comp. | Silica 4 | 1 | 1 | 0.170 | 0.027 | 0.167 | 0.026 |
| Ex. 4 | | | | | | | |
| Comp. | Titania 1 | 1 | 1 | 0.110 | 0.080 | 0.108 | 0.078 |
| Ex. 5 | | | | | | | |
| Comp. | Alumina 1 | 1 | 1 | 0.107 | 0.077 | 0.105 | 0.075 |
| Ex. 6 | | | | | | | |

TABLE 2B-2

| | Average | Cleaning | Cleaning | Cleaning | Film abrasion | | Regulation |
|---|---|---|---|---|---|---|---|
| | circularity | property | property | property | amount | | blade |
| | of toner | (1) | (2) | (3) | μm/1,000 | | contamination |
| Ex. 1 | 0.99 | B | C | C | 0.5 | C | A |
| Ex. 2 | 0.96 | A | B | B | 0.4 | B | B |
| Ex. 3 | 0.97 | A | A | A | 0.3 | A | C |
| Ex. 4 | 0.98 | A | A | A | 0.2 | A | C |
| Ex. 5 | 0.98 | A | B | B | 0.4 | B | B |
| Ex. 6 | 0.99 | A | B | B | 0.4 | B | B |
| Ex. 7 | 0.96 | A | B | B | 0.5 | C | A |
| Ex. 8 | 0.98 | A | B | B | 0.4 | A | B |
| Ex. 9 | 0.99 | B | C | C | 0.6 | C | A |
| Ex. 10 | 0.96 | A | B | B | 0.4 | B | B |
| Ex. 11 | 0.99 | B | C | C | 0.6 | C | C |
| Comp. | 0.99 | A | A | A | 0.3 | A | D |
| Ex. 1 | | | | | | | |
| Comp. | 0.96 | D | D | D | 1.0 | D | A |
| Ex. 2 | | | | | | | |
| Comp. | 0.95 | C | D | C | 0.8 | D | A |
| Ex. 3 | | | | | | | |
| Comp. | 0.95 | C | D | C | 0.8 | D | A |
| Ex. 4 | | | | | | | |
| Comp. | 0.97 | D | D | D | 1.0 | D | A |
| Ex. 5 | | | | | | | |
| Comp. | 0.98 | D | D | D | 1.0 | D | A |
| Ex. 6 | | | | | | | |

### Examples 1-1 to 11-2 and Comparative Examples 1-1 to 6-2

Toners of Examples 1-1 to 11-2 and Comparative Examples 1-1 to 6-2 were obtained in the same manner as in Example 1, provided that the external additives presented in Tables 3-1 and 4-1 were respectively used.

The obtained toners were evaluated in terms of the aforementioned cleaning properties (1) to (2) of the intermediate transfer member, film abrasion amount of the latent image bearing member, and contamination of the regulation blade. The results are presented in Table 3-2, and Table 4-2.

Table 3-1 is presented based on the carbon content, and Table 4-1 is presented based on the PDMS content.

It was found from the evaluation results presented in tables that the toner of the present invention excelled in the cleaning properties and the film abrasion amount compared to the toners of Comparative Examples.

TABLE 3-1

| | | Toner | | | | | |
|---|---|---|---|---|---|---|---|
| | | | | In silicone oil-treated | | | |
| | | | | external additive | | | |
| | | | | Total | | | Total |
| | | | | free | | Total free | remaining |
| | | Silicone | HMDS | carbon | Total | carbon | carbon |
| | | oil-treated | treated | amount | remaining | amount | amount |
| | | external | external | derived | carbon | derived | derived |
| | | additive | additive | from | amount | from | from |
| | | amount in | amount | silicone | derived from | silicone oil | silicone oil |
| | External | toner | in toner | oil | silicone oil | in toner | in toner |
| | additive | part | part | part | part | wt % | wt % |
| Ex. 1-1 | Silica 1 | 3 | 1 | 0.075 | 0.018 | 0.072 | 0.017 |
| Ex. 1-2 | | | | | | | |
| Ex. 2-1 | Silica 2 | 3 | 1 | 0.099 | 0.075 | 0.095 | 0.072 |
| Ex. 2-2 | | | | | | | |
| Ex. 3-1 | Silica 3 | 3 | 1 | 0.123 | 0.063 | 0.118 | 0.061 |
| Ex. 3-2 | | | | | | | |
| Ex. 4-1 | Silica 4 | 3 | 1 | 0.153 | 0.024 | 0.147 | 0.023 |
| Ex. 4-2 | | | | | | | |
| Ex. 5-1 | Silica 4 | 2 | 1 | 0.102 | 0.016 | 0.099 | 0.016 |
| Ex. 5-2 | | | | | | | |
| Ex. 6-1 | Silica 1 | 4 | 1 | 0.100 | 0.024 | 0.095 | 0.023 |
| Ex. 6-2 | | | | | | | |
| Ex. 7-1 | Titania 1 | 3 | 1 | 0.099 | 0.072 | 0.095 | 0.069 |
| Ex. 7-2 | | | | | | | |
| Ex. 8-1 | Alumina 1 | 3 | 1 | 0.096 | 0.069 | 0.092 | 0.066 |
| Ex. 8-2 | | | | | | | |
| Ex. 9-1 | Silica 7 | 3 | 1 | 0.063 | 0.025 | 0.060 | 0.024 |
| Ex. 9-2 | | | | | | | |
| Ex. 10-1 | Silica 8 | 2 | 1 | 0.104 | 0.060 | 0.101 | 0.058 |
| Ex. 10-2 | | | | | | | |
| Ex. 11-1 | Silica 9 | 3 | 1 | 0.111 | 0.045 | 0.107 | 0.043 |
| Ex. 11-2 | | | | | | | |
| Comp. | Silica 3 | 4 | 1 | 0.164 | 0.084 | 0.156 | 0.080 |
| Ex. 1-1 | | | | | | | |
| Comp. | | | | | | | |
| Ex. 1-2 | | | | | | | |
| Comp. | Silica 5 | 3 | 1 | 0.033 | 0.051 | 0.032 | 0.049 |
| Ex. 2-1 | | | | | | | |
| Comp. | | | | | | | |
| Ex. 2-2 | | | | | | | |
| Comp. | Silica 6 | 3 | 1 | 0.048 | 0.057 | 0.046 | 0.055 |
| Ex. 3-1 | | | | | | | |
| Comp. | | | | | | | |
| Ex. 3-2 | | | | | | | |
| Comp. | Silica 4 | 1 | 1 | 0.051 | 0.008 | 0.050 | 0.008 |
| Ex. 4-1 | | | | | | | |
| Comp. | | | | | | | |
| Ex. 4-2 | | | | | | | |
| Comp. | Titania 1 | 1 | 1 | 0.033 | 0.024 | 0.032 | 0.024 |
| Ex. 5-1 | | | | | | | |
| Comp. | | | | | | | |
| Ex. 5-2 | | | | | | | |
| Comp. | Alumina 1 | 1 | 1 | 0.032 | 0.023 | 0.031 | 0.023 |
| Ex. 6-1 | | | | | | | |
| Comp. | | | | | | | |
| Ex. 6-2 | | | | | | | |

TABLE 3-2

| | | Intermediate transfer | | | | | | | |
|---|---|---|---|---|---|---|---|---|---|
| | | cleaning | | | | | | | |
| | | Rebound | | | Evaluation result | | | | |
| | | resilience | Cleaning | Cleaning | | | | | Regula- |
| | Average | of | blade | blade | | | Film | | tion |
| | circularity | cleaning | contact | contact | Cleaning | Cleaning | abrasion | | blade |
| | of | blade | pressure | angle θ | property | property | amount | | contami- |
| | toner | % | N/m | ° | 1 | 2 | μm/1000 | | nation |
| Ex. 1-1 | 0.99 | 35 | 20 | 82 | C | A | 13 | C | A |
| Ex. 1-2 | | 55 | 50 | 70 | A | C | | | |
| Ex. 2-1 | 0.96 | 35 | 20 | 82 | B | A | 8 | B | B |
| Ex. 2-2 | | 55 | 50 | 70 | A | B | | | |
| Ex. 3-1 | 0.97 | 35 | 20 | 82 | A | A | 4 | A | C |
| Ex. 3-2 | | 55 | 50 | 70 | A | A | | | |
| Ex. 4-1 | 0.98 | 35 | 20 | 82 | A | A | 2 | A | C |
| Ex. 4-2 | | 55 | 50 | 70 | A | A | | | |
| Ex. 5-1 | 0.98 | 35 | 20 | 82 | A | A | 8 | B | B |
| Ex. 5-2 | | 55 | 50 | 70 | A | A | | | |
| Ex. 6-1 | 0.99 | 35 | 20 | 82 | B | A | 8 | B | B |
| Ex. 6-2 | | 55 | 50 | 70 | A | B | | | |
| Ex. 7-1 | 0.96 | 35 | 20 | 82 | B | A | 12 | C | A |
| Ex. 7-2 | | 55 | 50 | 70 | A | B | | | |
| Ex. 8-1 | 0.98 | 35 | 20 | 82 | B | A | 14 | C | B |
| Ex. 8-2 | | 55 | 50 | 70 | A | B | | | |
| Ex. 9-1 | 0.99 | 35 | 20 | 82 | C | B | 18 | C | A |
| Ex. 9-2 | | 55 | 50 | 70 | B | C | | | |
| Ex. 10-1 | 0.96 | 35 | 20 | 82 | A | A | 8 | B | B |
| Ex. 10-2 | | 55 | 50 | 70 | A | A | | | |
| Ex. 11-1 | 0.99 | 35 | 20 | 82 | A | A | 15 | C | C |
| Ex. 11-2 | | 55 | 50 | 70 | A | A | | | |
| Comp. | 0.99 | 35 | 20 | 82 | A | A | 1 | A | D |
| Ex. 1-1 | | | | | | | | | |
| Comp. | | 55 | 50 | 70 | A | A | | | |
| Ex. 1-2 | | | | | | | | | |
| Comp. | 0.96 | 35 | 20 | 82 | D | D | 34 | D | A |
| Ex. 2-1 | | | | | | | | | |
| Comp. | | 55 | 50 | 70 | D | D | | | |
| Ex. 2-2 | | | | | | | | | |
| Comp. | 0.95 | 35 | 20 | 82 | C | D | 22 | D | A |
| Ex. 3-1 | | | | | | | | | |
| Comp. | | 55 | 50 | 70 | D | C | | | |
| Ex. 3-2 | | | | | | | | | |
| Comp. | 0.95 | 35 | 20 | 82 | C | D | 22 | D | A |
| Ex. 4-1 | | | | | | | | | |
| Comp. | | 55 | 50 | 82 | D | C | | | |
| Ex. 4-2 | | | | | | | | | |
| Comp. | 0.97 | 35 | 20 | 82 | D | D | 40 | D | A |
| Ex. 5-1 | | | | | | | | | |
| Comp. | | 55 | 50 | 70 | D | D | | | |
| Ex. 5-2 | | | | | | | | | |
| Comp. | 0.98 | 35 | 20 | 82 | D | D | 43 | D | A |
| Ex. 6-1 | | | | | | | | | |
| Comp. | | 55 | 50 | 70 | D | D | | | |
| Ex. 6-2 | | | | | | | | | |

TABLE 4-1

| | | Toner | | | | | |
|---|---|---|---|---|---|---|---|
| | | | | In silicone | | | |
| | | Silicone | | oil-treated | | | |
| | | oil | HMDS | external additive | | Total | Total |
| | | treatment | treatment | | Total | free | remaining |
| | | External | External | Total free | remaining | PDMS | PDMS |
| | | additive | additive | PDMS | PDMS | amount | amount in |
| | External | amount | amount | amount | amount | in toner | toner |
| | additive | part | part | part | part | wt % | wt % |
| Ex. 1-1 | Silica 1 | 3 | 1 | 0.250 | 0.060 | 0.240 | 0.058 |
| Ex. 1-2 | | | | | | | |
| Ex. 2-1 | Silica 2 | 3 | 1 | 0.330 | 0.250 | 0.317 | 0.240 |
| Ex. 2-2 | | | | | | | |
| Ex. 3-1 | Silica 3 | 3 | 1 | 0.410 | 0.210 | 0.394 | 0.202 |
| Ex. 3-2 | | | | | | | |
| Ex. 4-1 | Silica 4 | 3 | 1 | 0.510 | 0.080 | 0.490 | 0.077 |
| Ex. 4-2 | | | | | | | |
| Ex. 5-1 | Silica 4 | 2 | 1 | 0.340 | 0.053 | 0.330 | 0.052 |
| Ex. 5-2 | | | | | | | |
| Ex. 6-1 | Silica 1 | 4 | 1 | 0.333 | 0.080 | 0.317 | 0.076 |
| Ex. 6-2 | | | | | | | |
| Ex. 7-1 | Titania 1 | 3 | 1 | 0.330 | 0.240 | 0.317 | 0.231 |
| Ex. 7-2 | | | | | | | |
| Ex. 8-1 | Alumina 1 | 3 | 1 | 0.320 | 0.230 | 0.308 | 0.221 |
| Ex. 8-2 | | | | | | | |
| Ex. 9-1 | Silica 7 | 3 | 1 | 0.208 | 0.083 | 0.201 | 0.081 |
| Ex. 9-2 | | | | | | | |
| Ex. 10-1 | Silica 8 | 2 | 1 | 0.347 | 0.200 | 0.337 | 0.194 |
| Ex. 10-2 | | | | | | | |
| Ex. 11-1 | Silica 9 | 3 | 1 | 0.370 | 0.150 | 0.356 | 0.144 |
| Ex. 11-2 | | | | | | | |
| Comp. | Silica 3 | 4 | 1 | 0.547 | 0.280 | 0.521 | 0.267 |
| Ex. 1-1 | | | | | | | |
| Comp. | | | | | | | |
| Ex. 1-2 | | | | | | | |
| Comp. | Silica 5 | 3 | 1 | 0.110 | 0.170 | 0.106 | 0.163 |
| Ex. 2-1 | | | | | | | |
| Comp. | | | | | | | |
| Ex. 2-2 | | | | | | | |
| Comp. | Silica 6 | 3 | 1 | 0.160 | 0.190 | 0.154 | 0.183 |
| Ex. 3-1 | | | | | | | |
| Comp. | | | | | | | |
| Ex. 3-2 | | | | | | | |
| Comp. | Silica 4 | 1 | 1 | 0.170 | 0.027 | 0.167 | 0.026 |
| Ex. 4-1 | | | | | | | |
| Comp. | | | | | | | |
| Ex. 4-2 | | | | | | | |
| Comp. | Titania 1 | 1 | 1 | 0.110 | 0.080 | 0.108 | 0.078 |
| Ex. 5-1 | | | | | | | |
| Comp. | | | | | | | |
| Ex. 5-2 | | | | | | | |
| Comp. | Alumina 1 | 1 | 1 | 0.107 | 0.077 | 0.105 | 0.075 |
| Ex. 6-1 | | | | | | | |
| Comp. | | | | | | | |
| Ex. 6-2 | | | | | | | |

TABLE 4-2

| | | Intermediate transfer | | | Evaluation result | | | | |
|---|---|---|---|---|---|---|---|---|---|
| | | cleaning | | | | | Abrasion | | |
| | | Rebound | | | | | amount | | |
| | | resilience | Cleaning | Cleaning | | | of inter- | | Regula- |
| | Average | of | blade | blade | | | mediate | | tion |
| | circularity | cleaning | contact | contact | Cleaning | Cleaning | transfer | | blade |
| | of | blade | pressure | angle θ | property | property | member | | contami- |
| | toner | % | N/m | ° | 1 | 2 | line/1000 | | nation |
| Ex. 1-1 | 0.99 | 35 | 20 | 82 | C | A | 13 | C | A |
| Ex. 1-2 | | 55 | 50 | 70 | A | C | | | |
| Ex. 2-1 | 0.96 | 35 | 20 | 82 | B | A | 8 | B | B |
| Ex. 2-2 | | 55 | 50 | 70 | A | B | | | |
| Ex. 3-1 | 0.97 | 35 | 20 | 82 | A | A | 4 | A | C |
| Ex. 3-2 | | 55 | 50 | 70 | A | A | | | |
| Ex. 4-1 | 0.98 | 35 | 20 | 82 | A | A | 2 | A | C |
| Ex. 4-2 | | 55 | 50 | 70 | A | A | | | |
| Ex. 5-1 | 0.98 | 35 | 20 | 82 | A | A | 8 | B | B |
| Ex. 5-2 | | 55 | 50 | 70 | A | A | | | |
| Ex. 6-1 | 0.99 | 35 | 20 | 82 | B | A | 8 | B | B |
| Ex. 6-2 | | 55 | 50 | 70 | A | B | | | |
| Ex. 7-1 | 0.96 | 35 | 20 | 82 | B | A | 12 | C | A |
| Ex. 7-2 | | 55 | 50 | 70 | A | B | | | |
| Ex. 8-1 | 0.98 | 35 | 20 | 82 | B | A | 14 | C | B |
| Ex. 8-2 | | 55 | 50 | 70 | A | B | | | |
| Ex. 9-1 | 0.99 | 35 | 20 | 82 | C | B | 18 | C | A |
| Ex. 9-2 | | 55 | 50 | 70 | B | C | | | |
| Ex. 10-1 | 0.96 | 35 | 20 | 82 | A | A | 8 | B | B |
| Ex. 10-2 | | 55 | 50 | 70 | A | A | | | |
| Ex. 11-1 | 0.99 | 35 | 20 | 82 | A | A | 15 | C | C |
| Ex. 11-2 | | 55 | 50 | 70 | A | A | | | |
| Comp. | 0.99 | 35 | 20 | 82 | A | A | 1 | A | D |
| Ex. 1-1 | | | | | | | | | |
| Comp. | | 55 | 50 | 70 | A | A | | | |
| Ex. 1-2 | | | | | | | | | |
| Comp. | 0.96 | 35 | 20 | 82 | D | D | 34 | D | A |
| Ex. 2-1 | | | | | | | | | |
| Comp. | | 55 | 50 | 70 | D | D | | | |
| Ex. 2-2 | | | | | | | | | |
| Comp. | 0.95 | 35 | 20 | 82 | C | D | 22 | D | A |
| Ex. 3-1 | | | | | | | | | |
| Comp. | | 55 | 50 | 70 | D | C | | | |
| Ex. 3-2 | | | | | | | | | |
| Comp. | 0.95 | 35 | 20 | 82 | C | D | 22 | D | A |
| Ex. 4-1 | | | | | | | | | |
| Comp. | | 55 | 50 | 82 | D | C | | | |
| Ex. 4-2 | | | | | | | | | |
| Comp. | 0.97 | 35 | 20 | 82 | D | D | 40 | D | A |
| Ex. 5-1 | | | | | | | | | |
| Comp. | | 55 | 50 | 70 | D | D | | | |
| Ex. 5-2 | | | | | | | | | |
| Comp. | 0.98 | 35 | 20 | 82 | D | D | 43 | D | A |
| Ex. 6-1 | | | | | | | | | |
| Comp. | | 55 | 50 | 70 | D | D | | | |
| Ex. 6-2 | | | | | | | | | |

Embodiments of the present invention are as follows:

<1> A toner, containing:

a binder resin;

a colorant; and

a silicone oil-treated external additive,

wherein the silicone oil-treated external additive contains free silicone oil, and a total amount of the free silicone oil is 0.2% by mass to 0.5% by mass relative to the toner, and

wherein the toner has the average circularity of 0.96 to 1.

<2> The toner according to <1>, wherein the external additive has BET specific surface area of 10 m²/g to 50 m²/g.
<3> The toner according to any of <1> or <2>, wherein the external additive has the average primary particle diameter of 30 nm to 150 nm.
<4> The toner according to any one of <1> to <3>, wherein the external additive is at least one selected from the group consisting of silica, titania, and alumina.
<5> The toner according to any one of <1> to <4>, wherein the external additive is silica.
<6> The toner according to any one of <1> to <5>, wherein the silicone oil-treated external additive contains silicone oil in an amount of 2 mg/m² to 10 mg/m² with respect to the surface area of the external additive.
<7> The toner according to any one of <1> to <6>, wherein the toner contains toner base particles to which the external additive is externally added, and the toner base particles are produced by the method containing:

dispersing, in an aqueous medium, an oil phase in which at least the binder resin and the colorant are dissolved or dispersed in an organic solvent; and

removing the organic solvent.

<8> The toner according to any one of <1> to <7>, wherein the binder resin is a polyester resin.
<9> The toner according to any of <7> or <8>, wherein a modified resin containing an isocyanate group at a terminal thereof is dissolved in the oil phase.
<10> The toner according to <9>, wherein the modified resin has a polyester skeleton.
<11> The toner according to any one of <1> to <6>, wherein the toner contains toner base particles to which the external additive is externally added, and

wherein the toner base particles each contain a core particle, and a shell layer, which is formed with vinyl resin particles, and is formed on a surface of the core particle, where the toner base particles are produced by the method containing:

dispersing, in an aqueous medium, an oil phase in which at least the binder resin and the colorant are dissolved or dispersed in an organic solvent, to thereby form a dispersion liquid; and

adding the vinyl resin particles to the dispersion liquid and mixing.

<12> The toner according to <11>, wherein the vinyl resin particles contain an aromatic compound containing a vinyl polymerizable functional group in an amount of 80% by mass or larger.
<13> The toner according to any of <11> or <12>, wherein the vinyl resin particles contain an aromatic compound containing a vinyl polymerizable functional group in an amount of 90% by mass or larger.
<14> The toner according to any one of <12> to <13>, wherein the vinyl resin particles are formed of a vinyl resin, and the vinyl resin is consisted of a polymer of the aromatic compound containing a vinyl polymerizable functional group.
<15> The toner according to any one of <12> to <14>, wherein the aromatic compound containing a vinyl polymerizable functional group is styrene.
<16> The toner according to any one of <1> to <15>, wherein the toner has the volume average particle diameter of 3 μm to 9 μm.
<17> The toner according to any one of <1> to <16>, wherein the toner has a ratio Dv/Dn of 1.25 or lower, where the ratio Dv/Dn is a ratio of the volume average particle diameter Dv of the toner to the number average particle diameter Dn of the toner.
<18> A toner container, containing:

a container; and

the toner as defined in any one of <1> to <17>, housed in the container.

<19> A developer, containing:

the toner as defined in any one of <1> to <17>.

<20> An image forming apparatus, containing:

a latent image bearing member configured to bear a latent image;

a charging unit configured to uniformly charge a surface of the latent image bearing member;

an exposing unit configured to exposing the charged surface of the latent image bearing member to light based on imaging data, to write a latent electrostatic image;

a toner removing unit containing a cleaning blade, and configured to remove a residual toner with cleaning blade after transferring;

a toner for visualizing the latent image;

a developing unit configured to supply the toner to the latent electrostatic image formed on the surface of the latent image bearing member to develop the latent electrostatic image to form a visible image;

a transferring unit configured to transfer the visible image formed on the surface of the latent image bearing member to a recording medium; and

a fixing unit configured to fix the visible image on the recording medium,

wherein the toner is the toner as defined in any one of <1> to <17>.

<21> The image forming apparatus according to <20>, wherein the cleaning blade has rebound resilience of 10% to 35%.
<22> The image forming apparatus according to any of <20> or <21>, wherein the cleaning blade is brought into contact with the latent image bearing member with the pressure of 20N/m to 50N/m.
<23> The image forming apparatus according to any one of <20> to <22>, wherein the cleaning blade is brought into contact with the latent image bearing member with a contact angle θ of 70° to 82°, where the contact angle θ is an angle formed between a plane of an edge of the cleaning blade facing the latent image bearing member and a tangent line extended from a contact point at which the cleaning blade and the surface of the latent image bearing member meets.
<24> The image forming apparatus according to any one of <20> to <23>, further comprising an intermediate transfer member, and an intermediate transfer member toner removing unit containing an intermediate transfer member cleaning blade,

wherein the transferring unit is configured to transfer the visible image formed on the surface of the latent image bearing member to an intermediate transfer member, and the intermediate transfer member toner removing unit is configured to remove the residual toner on the intermediate transfer member with the intermediate transfer member cleaning blade, after transferring, and

wherein the intermediate transfer member cleaning blade has rebound resilience of 35% to 55%, and the intermediate transfer member cleaning blade is brought into contact with the intermediate transfer member with the pressure of 20 N/m to 50 N/m, with a contact angle θ of 70° to 82°, where the contact angle θ is an angle formed between a plane of an edge of the cleaning blade facing the surface of the intermediate transfer member, and a tangent line extended from a contact point at which the intermediate transfer member cleaning blade and the surface of the intermediate transfer member meets.

<25> An image forming method, containing:

uniformly charging a surface of a latent image bearing member;

exposing the charged surface of the latent image bearing member to light based on imaging data to write a latent electrostatic image;

developing the latent electrostatic image formed on the surface of the latent image bearing member to form a visible image;

transferring the visible image on the surface of the latent image bearing member to a recording medium;

after the transferring, removing the residual toner with a cleaning blade to perform cleaning; and

fixing the visible image onto the recording medium,

wherein the toner as defined in any one of <1> to <17> is used to develop the latent electrostatic image in the developing.

<26> The image forming method according to <25>, wherein the cleaning blade has rebound resilience of 10% to 35%.
<27> The image forming method according to any of <25> or <26>, wherein the cleaning blade is brought into contact with the latent image bearing member with pressure of 20 N/m to 50 N/m.
<28> The image forming method according to any one of <25> to <27>, wherein the cleaning blade is brought into contact with the latent image bearing member with a contact angle θ of 70° to 82°, where the contact angle θ is an angle formed between a plane of an edge of the cleaning blade facing the latent image bearing member and a tangent line extended from a contact point at which the cleaning blade and of the surface of the latent image bearing member meets.
<29> A process cartridge, containing:

a latent image bearing member; and

at least a developing unit configured to develop a latent image formed on the latent image bearing member with a toner, where the developing unit is integrated with the latent image bearing member,

wherein the process cartridge is detachably mounted in the image forming apparatus as defined in any one of <30> to <32>, and

wherein the toner is the toner as defined in any one of <1> to <16>.

<30> An image forming image, containing:

a primary transferring unit configured to transfer a visible image on a surface of a latent image bearing member to an intermediate transfer member;

a latent image bearing member toner removing unit configured to remove, with a latent image bearing member cleaning blade, a toner remained on the surface of the latent image bearing member after the transferring of the visible image by the primary transferring unit;

a secondary transferring unit configured to transfer the transferred visible image on the intermediate transfer image to a recording medium; and

an intermediate transfer member toner removing unit configured to remove, with an intermediate transfer member cleaning blade, a toner remained on a surface of the intermediate transfer member after the transferring of the transferred image by the secondary transferring unit,

wherein the toner is the toner as defined in any one of <1> to <17>

<31> The image forming apparatus according to <30>, wherein the latent image bearing member cleaning blade has rebound resilience of 10% to 35%, and the latent image bearing member cleaning blade is brought into contact with the latent image bearing member with the pressure of 20 N/m to 50 N/m, with a contact angle θ of 70° to 82°, where the contact angle θ is an angle formed between a plane of an edge of the latent image bearing member cleaning blade facing the surface of the latent image bearing member, and a tangent line extended from a contact point at which the latent image bearing member cleaning blade and the surface of the latent image bearing member meets.
<32> The image forming apparatus according to <30>, wherein the intermediate transfer member cleaning blade has rebound resilience of 10% to 35%, and the intermediate transfer member cleaning blade is brought into contact with the intermediate transfer member with the pressure of 20 N/m to 50 N/m, with a contact angle θ of 70° to 82°, where the contact angle θ is an angle formed between a plane of an edge of the intermediate transfer member cleaning blade facing the surface of the intermediate transfer member, and a tangent line extended from a contact point at which the intermediate transfer member cleaning blade and the surface of the intermediate transfer member meets.

### REFERENCE SIGNS LIST

1: latent image bearing member
2: charging unit
3: exposing unit
4: developing unit
5: cleaning unit
6: intermediate transfer member
7: support roller
8: transfer roller
9: heat roller
10: aluminum core rod
11: elastic material layer
12: PFA surface layer
13: heater
14: pressure roller
15: aluminum core rod
16: elastic material layer
17: PFA surface layer
18: unfixed image
19: fixing unit
40: developing roller
41: thin layer forming member
42: supplying roller
L: exposure light
P: recording paper
T: toner
5b: cleaning blade
5b-1: plate cleaning blade
5b-2: supporting member
5c: toner collecting case
5d: rocking lever shaft
5e: moving member
5f: tension spring
5g: screw
θ: contact angle
101: intermediate transfer member cleaning blade
102: toner
103: stopper layer

1. A toner, comprising:
a binder resin;
a colorant; and
a silicone oil-treated external additive,
wherein:
the silicone oil-treated external additive comprises free silicone oil, such that a total amount of the free silicone oil is 0.2% by mass to 0.5% by mass relative to the toner; and
the toner has the average circularity of 0.96 to 1.

2. The toner according to claim 1, wherein the external additive has a BET specific surface area of 10 m²/g to 50 m²/g.

3. The toner according to claim 1, wherein the external additive has an average primary particle diameter of 30 nm to 150 nm.

4. The toner according to claim 1, wherein the external additive is at least one selected from the group consisting of silica, titania, and alumina.

5. The toner according to claim 1, wherein the external additive is silica.

6. The toner according to claim 1, wherein the silicone oil-treated external additive comprises silicone oil in an amount of 2 mg/m² to 10 mg/m² with respect to a surface area of the external additive.

7. An image forming image, comprising:
a primary transferring unit configured to transfer a visible image on a surface of a latent image bearing member to an intermediate transfer member;
a latent image bearing member toner removing unit configured to remove, with a latent image bearing member cleaning blade, a toner remained on the surface of the latent image bearing member after the transferring of the visible image by the primary transferring unit;
a secondary transferring unit configured to transfer the transferred visible image on the intermediate transfer image to a recording medium; and
an intermediate transfer member toner removing unit configured to remove, with an intermediate transfer member cleaning blade, a toner remained on a surface of the intermediate transfer member after the transferring of the transferred image by the secondary transferring unit,
wherein:
the toner comprises:
a binder resin;
a colorant; and
a silicone oil-treated external additive;
the silicone oil-treated external additive comprises free silicone oil, such that a total amount of the free silicone oil is 0.2% by mass to 0.5% by mass relative to the toner; and
the toner has the average circularity of 0.96 to 1.

8. The image forming apparatus according to claim 7, wherein the latent image bearing member cleaning blade has rebound resilience of 10% to 35%, and the latent image bearing member cleaning blade is brought into contact with the latent image bearing member with the pressure of 20 N/m to 50 N/m, with a contact angle θ of 70° to 82°, where the contact angle θ is an angle formed between a plane of an edge of the latent image bearing member cleaning blade facing the surface of the latent image bearing member, and a tangent line extended from a contact point at which the latent image bearing member cleaning blade and the surface of the latent image bearing member meets.

9. The image forming apparatus according to claim 7, wherein the intermediate transfer member cleaning blade has rebound resilience of 10% to 35%, and the intermediate transfer member cleaning blade is brought into contact with the intermediate transfer member with the pressure of 20 N/m to 50 N/m, with a contact angle θ of 70° to 82°, where the contact angle θ is an angle formed between a plane of an edge of the intermediate transfer member cleaning blade facing the surface of the intermediate transfer member, and a tangent line extended from a contact point at which the intermediate transfer member cleaning blade and the surface of the intermediate transfer member meets.

10. A process cartridge, comprising:
a latent image bearing member; and
at least a developing unit configured to develop a latent image formed on the latent image bearing member with a toner, where the developing unit is integrated with the latent image bearing member,
wherein:
the process cartridge is detachably mounted in an image forming apparatus;
the image forming apparatus comprises:
a primary transferring unit configured to transfer a visible image on a surface of a latent image bearing member to an intermediate transfer member;
a latent image bearing member toner removing unit configured to remove, with a latent image bearing member cleaning blade, a toner remained on the surface of the latent image bearing member after the transferring of the visible image by the primary transferring unit;
a secondary transferring unit configured to transfer the transferred visible image on the intermediate transfer image to a recording medium; and
an intermediate transfer member toner removing unit configured to remove, with an intermediate transfer member cleaning blade, a toner remained on a surface of the intermediate transfer member after the transferring of the transferred image by the secondary transferring unit;
the toner comprises:
a binder resin;
a colorant; and
a silicone oil-treated external additive;
the silicone oil-treated external additive comprises free silicone oil, such that a total amount of the free silicone oil is 0.2% by mass to 0.5% by mass relative to the toner; and
the toner has the average circularity of 0.96 to 1.

11. The toner according to claim 2, wherein the external additive has an average primary particle diameter of 30 nm to 150 nm.

12. The toner according to claim 2, wherein the external additive is at least one selected from the group consisting of silica, titania, and alumina.

13. The toner according to claim 2, wherein the external additive is silica.

14. The toner according to claim 2, wherein the silicone oil-treated external additive comprises silicone oil in an amount of 2 mg/m² to 10 mg/m² with respect to a surface area of the external additive.
